(19) United States
(12) Patent Application Publication
(10) Pub. No.: US 2024/0040523 A1
(43) Pub. Date: Feb. 1, 2024

(54) Adjusting Awake Times for Uplink and Downlink Spanning Multiple Protocols

(71) Applicant: QUALCOMM Incorporated, San Diego, CA (US)

(72) Inventors: Hyun Yong LEE, San Diego, CA (US); Ravi AGARWAL, San Diego, CA (US); Qi XUE, San Diego, CA (US); Peerapol TINNAKORNSRISUPHAP, San Diego, CA (US); Sanghamitra BHATTACHARYA, San Diego, CA (US); Yuan ZHOU, San Diego, CA (US)

(21) Appl. No.: 17/815,263

(22) Filed: Jul. 27, 2022

(51) Int. Cl. H04W 56/00; H04W 76/14; H04W 76/28; H04W 52/02

(52) U.S. Cl. CPC H04W 56/0015; H04W 76/14; H04W 76/28; H04W 52/0248

(57) ABSTRACT

Various embodiments include methods implemented in user equipment (UE) for synchronizing resource timings of at least two wireless protocols. The UE may obtain communication timing information of a user device, send the communication timing information of the user device to a network node, and configure first resource timings of an uplink or downlink between the UE and the user device based on the communication timing information. The UE may request configuration of second resource timings of a further uplink or downlink between the UE and the network node based on the communication timing information. Sending communication timing information may include requesting a discontinuous reception (DRX) configuration adjustment so that a DRX cycle of the UE and a target wake time (TWT) of the user device at least partially coincide. Configuring first resource timings may include adjusting a timing of the TWT based on a DRX configuration for the user device.

### BACKGROUND

Long Term Evolution (LTE), Fifth Generation (5G) New Radio (NR), and other communication technologies enable improved communication and data services. One such service is augmented reality (AR) or extended reality (XR) which demands low latency and high-bandwidth for real-time processing. Some of this data bandwidth may be allocated to other transmission networks, such as a wireless local area network (WLAN) which may be a Wi-Fi network with a connection to the Internet. However, the non-5G communication network may operate at different times and cause a user device to always be transmitting and receiving, creating a low battery and energy performance.

### SUMMARY

Various aspects include systems and methods performed by user equipment (UE) for improving wireless communications by enabling synchronization of communications windows between protocols and/or between portions of downlink and uplink communication chains. Various aspects may include obtaining communication timing information of a user device, sending the communication timing information of the user device to a network node; and
configuring first resource timings of an uplink or downlink between the UE and the user device based on the communication timing information. Some aspects may further include requesting configuration of second resource timings of a further uplink or downlink between the UE and the network node based on the communication timing information. In some aspects, sending the communication timing information may further include requesting adjustment, by the network node, of a discontinuous reception (DRX) configuration so that a DRX cycle of the UE and a target wake time (TWT) of the user device at least partially coincide.

In some aspects, configuring the first resource timings may further include adjusting a timing of a target wake time (TWT) based on a discontinuous reception (DRX) configuration for the user device. In some aspects, adjusting the timing of the TWT comprises setting a TWT interval and a TWT start based on a DRX cycle and a DRX offset of the UE, respectively, wherein the DRX cycle and the DRX offset are configured by the network node. In some aspects, adjusting the timing of the TWT comprises setting a TWT minimum wake duration based on a jitter of arrival time of periodic data traffic received by the UE.

In some aspects, configuring the first resource timings may further include adjusting, for downlink traffic from the UE to the user device, a timing of a target wake time (TWT) based on a discontinuous reception (DRX) configuration of the UE, a physical downlink shared channel (PDSCH) traffic pattern between the UE and the network node, or semi-permanent scheduling of the network node. In some aspects, configuring the first resource timings may further include adjusting, for uplink traffic from the user device to the UE, a timing of at least one of a bandwidth physical uplink shared channel (PUSCH), a configure grant of the network node based on a TWT of the user device, or an assistance message from the user device. Some aspects may further include the UE proactively sending a scheduling request (SR) for the PUSCH before data is received from the user device by considering one or both of latency of the SR or latency of a buffer status report (BSR).

In some aspects, configuring the first resource timings may further include sending the communication timing information may further include generating, via a cross-layer application programming interface (API) on the UE, one or more assistance data messages that include the communication timing information of the user device, and transmitting the one or more assistance data messages to the network node. In some aspects, configuring the first resource timings may further include adjusting a timing of a target wake time (TWT) of the user device to at least partially coincide with a discontinuous reception (DRX) cycle of the UE based on a DRX configuration for the UE received from the network node. In some aspects, configuring the first resource timings may further include adjusting a timing of a target wake time (TWT) of the user device based on downlink traffic from the network node. In some aspects, configuring the first resource timings may further include requesting adjustment of a physical uplink shared channel (PUSCH) resource of the UE to at least partially coincide with a TWT of the user device based on the communication timing information.

Some aspects may further include receiving a data generation timing, in which wherein configuring the first resource timings may include sending to the network node a request to adjust a physical uplink shared channel (PUSCH) resource of the UE based on the data generation timing or sending to the network node a request to adjust the data generation timing.

In some aspects, configuring the first resource timings may further include one or both of adjusting a timing of the uplink from the user device to the UE to at least partially coincide with a further uplink from the UE to the network node based on the communication timing information, or adjusting a timing of the downlink from the UE to the user device to at least partially coincide with a further downlink from the network node to the UE based on the communication timing information.

Further aspects include a UE having a processor configured to perform one or more operations of any of the methods summarized above. Further aspects include processing devices for use in a UE configured with processor-executable instructions to perform operations of any of the methods summarized above. Further aspects include a non-transitory processor-readable storage medium having stored thereon processor-executable instructions configured to cause a processor of a UE to perform operations of any of the methods summarized above. Further aspects include a UE having means for performing functions of any of the methods summarized above. Further aspects include a system on chip for use in a UE and that includes a processor configured to perform one or more operations of any of the methods summarized above.

Further aspects include methods for synchronizing resource timings of at least two wireless protocols performed by a processor of a network node. Such aspects may include receiving, from a user equipment (UE), one or more assistance data messages that include communication timing information of a user device connected to the UE configuring a resource timing of the network node based on the communication timing information, and informing the UE of the adjusted PUSCH resource. In some aspects, configuring a resource timing of the network node based on the communication timing information may include adjusting a physical uplink shared channel (PUSCH) resource allocated to the UE to at least partially coincide with a target awake time (TWT) of the user device, a timing of the TWT being included in the communication timing information. In some aspects, configuring a resource timing of the network node based on the communication timing information may include adjusting a physical uplink shared channel (PUSCH) resource allocated to the UE based on the communication timing information, wherein the communication timing information relates to a data generation timing at the user device.

Further aspects include a network node having a processor configured to perform one or more operations of any of the methods summarized above. Further aspects include a non-transitory processor-readable storage medium having stored thereon processor-executable instructions configured to cause a processor of a network node to perform operations of any of the methods summarized above. Further aspects include a network node having means for performing functions of any of the methods summarized above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1A is a system block diagram illustrating an example communications system suitable for implementing any of the various embodiments.

FIG. 1B is a system block diagram illustrating an example communications system suitable for implementing any of the various embodiments.

FIG. 1C is a system block diagram illustrating an example disaggregated base station architecture suitable for implementing any of the various embodiments.

FIG. 2A is a transmission downlink timing block diagram illustrating an example communications timing according to various embodiments.

FIG. 2B is a transmission uplink timing block diagram illustrating an example communications timing according to various embodiments.

FIG. 3A is a system block diagram illustrating a flow of wireless communications suitable to implement various embodiments.

FIG. 3B is a system block diagram illustrating a flow of wireless communications suitable to implement various embodiments.

FIG. 4A is a system block diagram illustrating a flow of wireless communications suitable to implement various embodiments.

FIG. 4B is a system block diagram illustrating a flow of wireless communications suitable to implement various embodiments.

FIG. 5A is a system block diagram illustrating a flow of wireless communications suitable to implement various embodiments.

FIG. 5B is a system block diagram illustrating a flow of wireless communications suitable to implement various embodiments.

FIG. 6A is a block diagram illustrating a computing device in a network suitable for implementing various embodiments.

FIG. 6B is a block diagram illustrating a computing device in a network suitable for implementing various embodiments.

FIG. 7 is a transmission downlink timing block diagram illustrating an example communications timing according to various embodiments.

FIG. 8 is a process flow diagram illustrating an example process suitable for implementing various embodiments.

FIG. 9A is a process flow diagram illustrating an example process suitable for implementing various embodiments.

FIG. 9B is a process flow diagram illustrating an example process suitable for implementing some embodiments.

FIG. 10A is a transmission uplink timing block diagram illustrating an example communications timing according to some embodiments.

FIG. 10B is a transmission uplink timing block diagram illustrating an example communications timing according to some embodiments.

FIG. 11 is a process flow diagram illustrating an example process suitable for implementing some embodiments.

FIG. 12 is a process flow diagram illustrating an example process suitable for implementing some embodiments.

FIG. 13 is a component block diagram of an example of smart glasses suitable for use with various embodiments.

FIG. 14 is a component block diagram of a UE suitable for use with various embodiments.

FIG. 15 is a component block diagram of connected processors suitable for implementing various embodiments.

FIG. 16 is a component block diagram of a network device suitable for use with various embodiments.

### DETAILED DESCRIPTION

Various embodiments and implementations will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various implementations include systems and methods for synchronizing awake times or ON times of various wireless communication protocols for wireless user equipment (UE). According to various aspects, a UE may establish a communication link between a network node and a user device such as extended reality (XR) glasses. The XR glasses may utilize a backend server for graphics processing and other power intensive tasks. The UE may connect as a bridge between the XR/AR glasses and the cellular network connected to the extended reality compute server. The XR glasses may include a Wi-Fi link to the UE and a separate cellular link. The system and methods of various embodiments provide synchronization of these various communication links so as to reduce ON times for transceivers in the XR glasses, thereby conserving power in the UE.

Various embodiments improve wireless communications by enabling synchronization of communications windows between protocols and/or between portions of a downlink/uplink chain, in which different portions of a downlink/uplink chain may be different protocols. Various aspects of this disclosure improve wireless communications by providing an enhanced messaging process that informs devices along an uplink/downlink path of preferred timings and communications windows.

The term “user equipment” (UE) is used herein to refer to any one or all of wireless communication devices, wireless appliances, cellular telephones, smartphones, portable computing devices, personal or mobile multi-media players, laptop computers, tablet computers, smartbooks, ultrabooks, palmtop computers, wireless electronic mail receivers, multimedia Internet-enabled cellular telephones, wireless router devices, medical devices and equipment, biometric sensors/devices, wearable devices including smart watches, smart clothing, smart glasses, smart wrist bands, smart jewelry (for example, smart rings and smart bracelets), entertainment devices (for example, wireless gaming controllers, music and video players, satellite radios, etc.), wireless-network enabled Internet of Things (IoT) devices including smart meters/sensors, industrial manufacturing equipment, large and small machinery and appliances for home or enterprise use, wireless communication elements within autonomous and semiautonomous vehicles, wireless devices affixed to or incorporated into various mobile platforms, global positioning system devices, and similar electronic devices that include a memory, wireless communication components and a programmable processor.

The term “user device” is used herein to refer generally to devices that may communicate with UE to receive downlink signals and send uplink according to various embodiments and implementations. Various embodiments are particularly useful for AR glasses, which are a type of user devices. Therefore, in the following embodiments the terms “user device” and “AR glasses” may be used interchangeably.

The term “system on chip” (SOC) is used herein to refer to a single integrated circuit (IC) chip that contains multiple resources or processors integrated on a single substrate. A single SOC may contain circuitry for digital, analog, mixed-signal, and radio-frequency functions. A single SOC also may include any number of general purpose or specialized processors (digital signal processors, modem processors, video processors, etc.), memory blocks (such as ROM, RAM, Flash, etc.), and resources (such as timers, voltage regulators, oscillators, etc.). SOCs also may include software for controlling the integrated resources and processors, as well as for controlling peripheral devices.

The term “system in a package” (SIP) may be used herein to refer to a single module or package that contains multiple resources, computational units, cores or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high speed communication circuitry and packaged in close proximity, such as on a single motherboard or in a single wireless device. The proximity of the SOCs facilitates high speed communications and the sharing of memory and resources.

As used herein, the terms “network,” “system,” “wireless network,” “cellular network,” and “wireless communication network” may interchangeably refer to a portion or all of a wireless network of a carrier associated with a wireless device and/or subscription on a wireless device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement Enhanced Data rates for global system for mobile communications (GSM) Evolution (EDGE). In another example, an OFDMA network may implement Evolved UTRA (E-UTRA) (including LTE standards), Institute of Electrical and Electronics Engineers (IEEE) 802.11 (Wi-Fi), IEEE 802.16 (WiMAX), IEEE 802.20, Flash-OFDM®, etc. Reference may be made to wireless networks that use LTE standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various Third Generation (3G) systems, Fourth Generation (4G) systems, and Fifth Generation (5G) systems are discussed herein, those systems are referenced merely as examples and future generation systems (e.g., sixth generation (6G) or higher systems) may be substituted in the various examples.

Augmented reality (AR) or extended reality (XR) technologies hold promise to be the next frontier of media by adding, extending, or overlaying additional features and information on the world that we sense around us. Because augmented reality or extended reality are added to the user experience as a part of the real world, these technologies necessarily include the real-time aspects. In addition, AR and XR media may primarily be audiovisual. At present, the real time projection of audiovisual overlays and information on lenses through which the real world is viewed requires substantial computer processing and electric power. As a result, battery resources on portable augmented reality or extended reality user devices are in high demand or require conservation. In some implementations, computing tasks associated with AR and XR media processing is performed in one or more cloud resources with processed media transmitted to the VR/XR glasses so as to preserve battery power on the UE and/or VR/XR glasses.

In applications in which computation and rendering processing are transferred to an external server, the bandwidth and latency of the communications link between the portable user device and the backend server may become the bottleneck for the application. Further, despite outsourcing such processing to an external server, battery resources may remain an important consideration. Accordingly, efficiency for the communications link between the portable user device and the back and server remains important. The system and processes disclosed herein may improve the efficiency of the communications link in various aspects including power usage and bandwidth allocation.

In some implementations, the portable user device providing an extended reality experience may be augmented reality (AR) glasses. AR glasses may project or display one or more graphics on lenses thereof and may emit sounds from the frame or temples thereof. The AR glasses may also allow the user to see through the lenses to view the real world at the same time as graphics are displayed on the lenses. In order to appropriately align the display graphics with the real world seen through the lenses, the AR glasses may record or monitor the pose, orientation, eye-direction, and movement of the user. To support the rendering process to match up with the user's field of view, an external server may require the pose, orientation, eye direction, or movement of the user before beginning calculations. Accordingly, in implementations in which extended reality processing is transferred to an external server, the timing between the upload of pose information and the download of completed renderings may have specific latency demands. The system and processes of various embodiments may reduce latency within this loop.

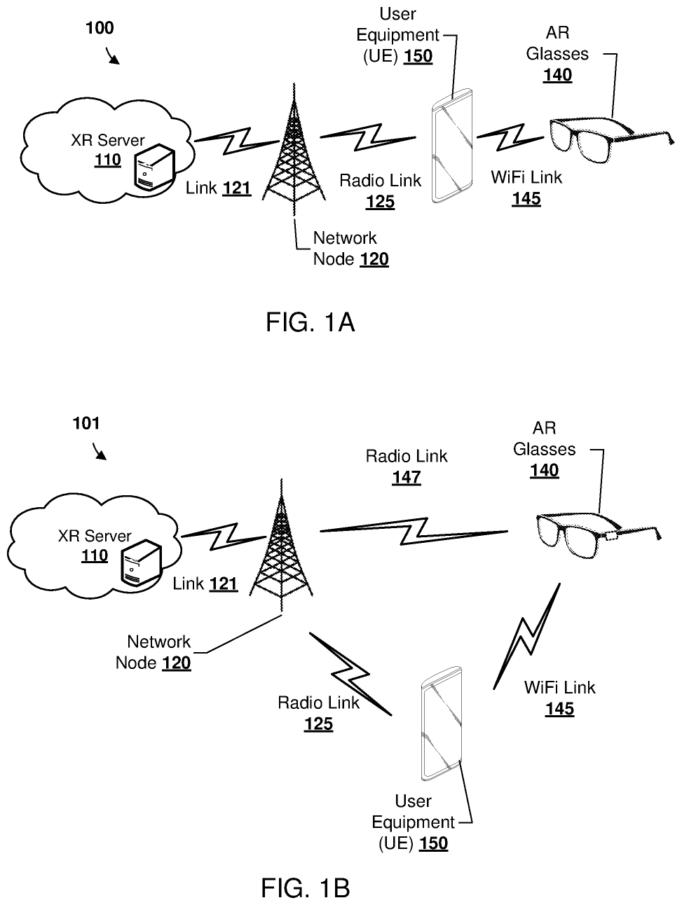

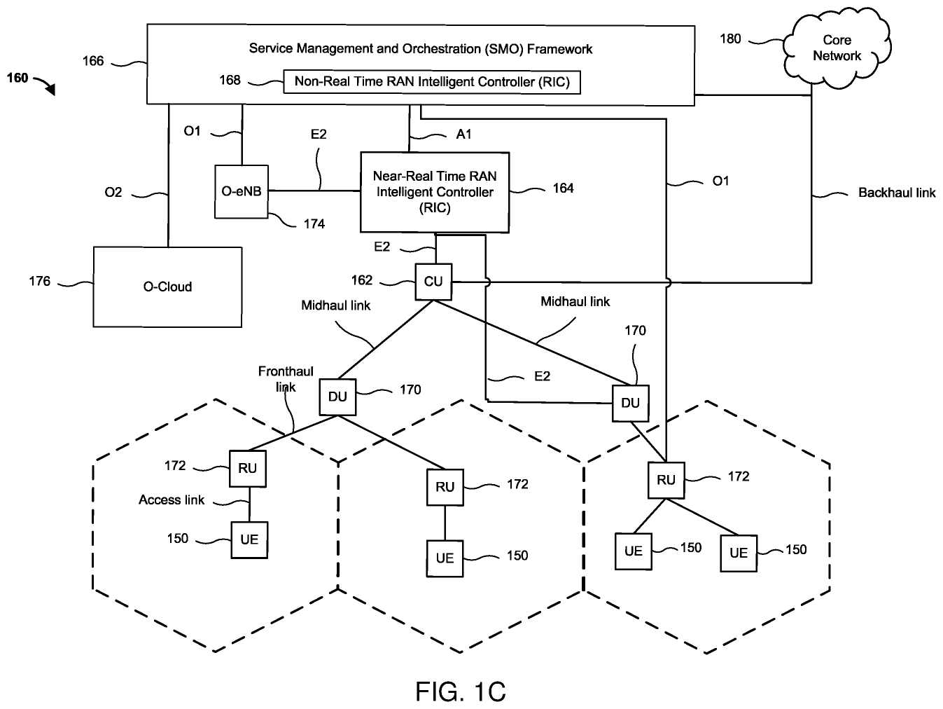

FIG. 1A is a system diagram illustrating an example communication system 100 providing a communication link between AR glasses 140 and XR server 110. As described above, the AR glasses 140 may require additional processing that is performed on the XR server 110 and correspondingly the XR server 110 may require pose information from the AR glasses 140. Therefore, example communication system 100 may include an uplink channel and downlink channel or uplink resources and downlink resources. One or more of the links or connections within the example communication system 100 may be wireless or wired. The devices illustrated in FIG. 1A are merely examples and may be other computing devices or communication devices.

As illustrated, the AR glasses 140 may connect via a Wi-Fi link 145 to the user equipment (UE) 150, which may connect via radio link 125 to a network node 120, which may connect the link 120 to an XR server 110. The radio link 125 may be provided over a 5G New Radio (NR) network, or any other suitable network such as a Long-Term Evolution (LTE) network or later generation network. Therefore, the reference to a 5G network and 5G network elements in the following descriptions is for illustrative purposes and is not intended to be limiting. The communication system 100 may be a heterogeneous network including peer-to-peer links, relay links, and one or more links to a network node (e.g., network node 120). The XR server 110 may be provided on the backend and connected to the network node 120 via a backhaul link or other network link. The various connections in the 5G radio system are described in more detail in FIG. 1C.

In example communication system 100, the AR glasses 140 may include a Wi-Fi transceiver to connect to the user equipment (UE) 150 and other Wi-Fi resources in which the Wi-Fi transceiver transmits and receives signals over an uplink and downlink defined one of the Wi-Fi standard protocols. The UE 150 may include the Wi-Fi transceiver for communication with the AR glasses 140 and a 5G transceiver for communication with the network node 120. The radio link 125 may be a cellular wireless link defined by the 5G standard protocol or other suitable protocol.

FIG. 1B is a system diagram illustrating an example communication system 101 providing a communication link between AR glasses 140 and XR server 110. In the example communication system 101 illustrated in FIG. 1B, the AR glasses 140 may connect to one or more UEs 150 via the Wi-Fi link 145 and connect to the network node 120 via a radio link 147, which may be a cellular wireless link defined by the 5G standard protocol or other suitable protocol. The UE 150 may connect to the network node over the radio link 125 in parallel with the radio link 147. That is, the radio link 147 and radio link 125 may share bandwidth resources. In addition, the Wi-Fi link 145 may be replaced with or assisted by a peer-to-peer 5G sidelink connection which may share resources with the radio links 125 and 147. Accordingly, in the example communication system 101, the AR glasses 140 may connect to the XR server 110 via the radio link 147 and/or the Wi-Fi link 145. The AR glasses 140 may include a Wi-Fi transceiver and a radio (5G) transceiver.

The communication system 100 or 101 may include a number of network nodes 120 and other network entities, such as base stations and other UEs. A network node is an entity that communicates with UEs and may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like.

In various communication network implementations or architectures, a network node may be implemented as an aggregated base station, as a disaggregated base station, an integrated access and backhaul (IAB) node, a relay node, a sidelink node, etc., such as a virtualized Radio Access Network (vRAN) or Open Radio Access Network (O-RAN). Also, in various communication network implementations or architectures, a network device (or network entity) may be implemented in an aggregated or monolithic base station architecture, or alternatively, in a disaggregated base station architecture, may include one or more of a Centralized Unit (CU), a Distributed Unit (DU), a Radio Unit (RU), a near-real time (RT) RAN intelligent controller (RIC), or a non-real time RIC. Each network device may provide communication coverage for a particular geographic area. In 3GPP, the term “cell” can refer to a coverage area of a network device, a network device subsystem serving this coverage area, or a combination thereof, depending on the context in which the term is used.

A network node 120 may provide communication coverage for a macro cell, a pico cell, a femto cell, another type of cell, or a combination thereof. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A network node for a macro cell may be referred to as a macro node or macro base station. A network node for a pico cell may be referred to as a pico node or a pico base station. A network node for a femto cell may be referred to as a femto node, a femto base station, a home node or home network device. The terms “network device,” “network node,” “eNB,” “base station,” “NR BS,” “gNB,” “TRP,” “AP,” “node B,” “5G NB,” and “cell” may be used interchangeably herein.

In some examples, a cell may not be stationary, and the geographic area of the cell may move according to the location of a network device. In some examples, the network nodes may be interconnected to one another as well as to one or more other network devices (e.g., base stations or network nodes (not illustrated)) in the communication system 100 through various types of backhaul interfaces, such as a direct physical connection, a virtual network, or a combination thereof using any suitable transport network.

The network node 120 may communicate with the backend servers (e.g., XR server 110) over a wired or wireless communication link (e.g., link 121). The UE 150 may communicate with the network node 120 over a wireless communication link 125. The wired communication link for the backend (e.g., link 121) may use a variety of wired networks (such as Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communication system 100 also may include relay stations may receive a transmission of data from an upstream station (for example, a network node or a UE) and send a transmission of the data to a downstream station (for example, a UE or a network node). A relay station also may be a UE that can relay transmissions for other UEs. A network controller may couple to a set of network nodes and may provide coordination and control for these network nodes. The network controller may communicate with the network bodes via a backhaul, midhaul, and/or fronthaul. The network nodes also may communicate with one another, for example, directly or indirectly via a wireless or wireline backhaul.

The communication system 100 or 101 may be a heterogeneous network that includes network devices of different types, for example, macro network devices, pico network devices, femto network devices, relay network devices, etc. These different types of network devices may have different transmit power levels, different coverage areas, and different impacts on interference in communication system 100. For example, macro nodes may have a high transmit power level (for example, 5 to 40 Watts) whereas pico network devices, femto network devices, and relay network devices may have lower transmission power levels (for example, 0.1 to 2 Watts). The UEs (e.g., UE 150) may be dispersed throughout communication system 100, and each UE may be stationary or mobile. A UE also may be referred to as an access terminal, a terminal, a mobile station, a subscriber unit, a user station, wireless device, etc.

The wireless communication links (e.g., radio link 125 or radio link 147) may include a plurality of carrier signals, frequencies, or frequency bands, each of which may include a plurality of logical channels. The wireless communication links may utilize one or more radio access technologies (RATs). Examples of RATs that may be used in a wireless communication link include 3GPP LTE, 3G, 4G, 5G (such as NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

In general, any number of communications systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, 4G/LTE and/or 5G/NR RAT networks may be deployed. For example, a 5G non-standalone (NSA) network may utilize both 4G/LTE RAT in the 4G/LTE RAN side of the 5G NSA network and 5G/NR RAT in the 5G/NR RAN side of the 5G NSA network. The 4G/LTE RAN and the 5G/NR RAN may both connect to one another and a 4G/LTE core network (e.g., an evolved packet core (EPC) network) in a 5G NSA network. Other example network configurations may include a 5G standalone (SA) network in which a 5G/NR RAN connects to a core network.

Deployment of communication systems, such as 5G NR systems, may be arranged in multiple manners with various components or constituent parts. In a NR system, or network, a network node, a network entity, a mobility element of a network, a radio access network (RAN) node, a core network node, a network element, or a network equipment, such as a base station (BS), or one or more units (or components) performing base station functionality, may be implemented in an aggregated or disaggregated architecture. For example, a base station (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or as a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CUs, DUs and RUs also can be implemented as virtual units, referred to as a virtual central unit (VCU), a virtual distributed unit (VDU), or a virtual radio unit (VRU).

Base station-type operations or network design may consider aggregation characteristics of base station functionality. For example, disaggregated base stations may be utilized in an integrated access backhaul (IAB) network, an open radio access network (O-RAN) (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 1C is a system block diagram illustrating an example disaggregated base station 160 architecture suitable for implementing any of the various embodiments. With reference to FIGS. 1A, 1B and 1C, the disaggregated base station 160 architecture may include one or more central units (CUs) 162 that can communicate directly with a core network 180 via a backhaul link, or indirectly with the core network 180 through one or more disaggregated base station units, such as a Near-Real Time (Near-RT) RAN Intelligent Controller (RIC) 164 via an E2 link, or a Non-Real Time (Non-RT) RIC 168 associated with a Service Management and Orchestration (SMO) Framework 166, or both. A CU 162 may communicate with one or more distributed units (DUs) 170 via respective midhaul links, such as an F1 interface. The DUs 170 may communicate with one or more radio units (RUs) 172 via respective fronthaul links. The RUs 172 may communicate with respective UEs 120 via one or more radio frequency (RF) access links. In some implementations, the UE 120 may be simultaneously served by multiple RUs 172.

Each of the units (i.e., CUs 162, DUs 170, RUs 172), as well as the Near-RT RICs 164, the Non-RT RICs 168 and the SMO Framework 166, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 162 may host one or more higher layer control functions. Such control functions may include the radio resource control (RRC), packet data convergence protocol (PDCP), service data adaptation protocol (SDAP), or the like. Each control function may be implemented with an interface configured to communicate signals with other control functions hosted by the CU 162. The CU 162 may be configured to handle user plane functionality (i.e., Central Unit-User Plane (CU-UP)), control plane functionality (i.e., Central Unit-Control Plane (CU-CP)), or a combination thereof. In some implementations, the CU 162 can be logically split into one or more CU-UP units and one or more CU-CP units. The CU-UP unit can communicate bidirectionally with the CU-CP unit via an interface, such as the E1 interface when implemented in an O-RAN configuration. The CU 162 can be implemented to communicate with DUs 170, as necessary, for network control and signaling.

The DU 170 may correspond to a logical unit that includes one or more base station functions to control the operation of one or more RUs 172. In some aspects, the DU 170 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 170 may further host one or more low PHY layers. Each layer (or module) may be implemented with an interface configured to communicate signals with other layers (and modules) hosted by the DU 170, or with the control functions hosted by the CU 162.

Lower-layer functionality may be implemented by one or more RUs 172. In some deployments, an RU 172, controlled by a DU 170, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 172 may be implemented to handle over the air (OTA) communication with one or more UEs 120. In some implementations, real-time and non-real-time aspects of control and user plane communication with the RU(s) 172 may be controlled by the corresponding DU 170. In some scenarios, this configuration may enable the DU(s) 170 and the CU 162 to be implemented in a cloud-based RAN architecture, such as a vRAN architecture.

The SMO Framework 166 may be configured to support RAN deployment and provisioning of non-virtualized and virtualized network elements. For non-virtualized network elements, the SMO Framework 166 may be configured to support the deployment of dedicated physical resources for RAN coverage requirements, which may be managed via an operations and maintenance interface (such as an O1 interface). For virtualized network elements, the SMO Framework 166 may be configured to interact with a cloud computing platform (such as an open cloud (O-Cloud) 176) to perform network element life cycle management (such as to instantiate virtualized network elements) via a cloud computing platform interface (such as an O2 interface). Such virtualized network elements can include, but are not limited to, CUs 162, DUs 170, RUs 172 and Near-RT RICs 164. In some implementations, the SMO Framework 166 may communicate with a hardware aspect of a 4G RAN, such as an open eNB (O-eNB) 174, via an O1 interface. Additionally, in some implementations, the SMO Framework 166 may communicate directly with one or more RUs 172 via an O1 interface. The SMO Framework 166 also may include a Non-RT RIC 168 configured to support functionality of the SMO Framework 166.

The Non-RT RIC 168 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 164. The Non-RT RIC 168 may be coupled to or communicate with (such as via an A1 interface) the Near-RT RIC 164. The Near-RT RIC 164 may be configured to include a logical function that enables near-real-time control and optimization of RAN elements and resources via data collection and actions over an interface (such as via an E2 interface) connecting one or more CUs 162, one or more DUs 170, or both, as well as an O-eNB, with the Near-RT RIC 164.

In some implementations, to generate AI/ML models to be deployed in the Near-RT RIC 164, the Non-RT RIC 168 may receive parameters or external enrichment information from external servers. Such information may be utilized by the Near-RT RIC 164 and may be received at the SMO Framework 166 or the Non-RT RIC 168 from non-network data sources or from network functions. In some examples, the Non-RT RIC 168 or the Near-RT RIC 164 may be configured to tune RAN behavior or performance. For example, the Non-RT RIC 168 may monitor long-term trends and patterns for performance and employ AI/ML models to perform corrective actions through the SMO Framework 166 (such as reconfiguration via O1) or via creation of RAN management policies (such as A1 policies).

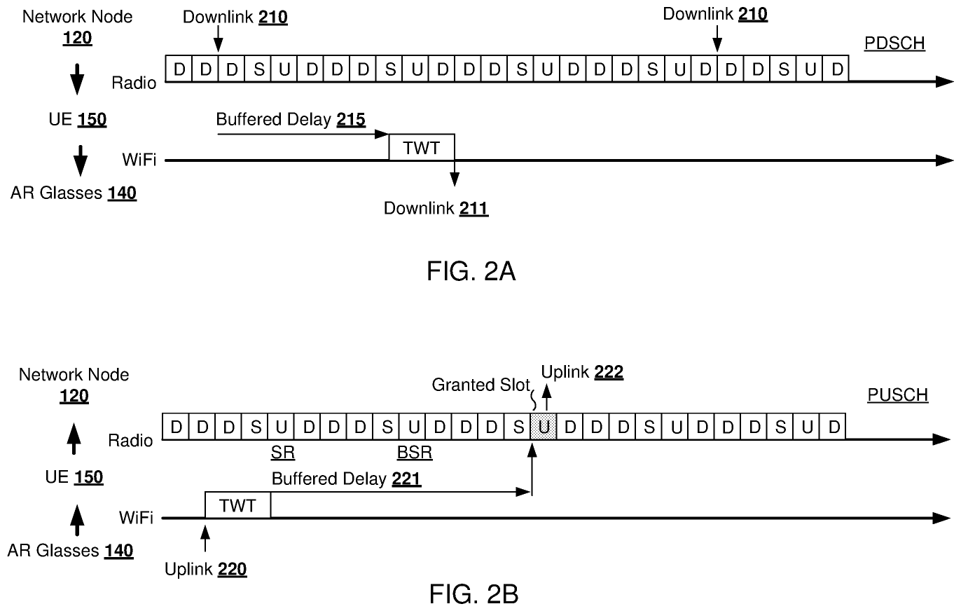

FIG. 2A is a communications timing diagram for a downlink from a network node 120 to user devices, such as AR glasses 140. With reference to FIGS. 1A-2A, the data communicated in the downlink may originate at an XR server 110 or other remote resources. The connection between the network node 120 and the UE 150 may be a radio channel and may be a physical downlink shared channel (PDSCH) or similar downlink shared channel (e.g., LTE downlink shared channel—DL-SCH). The connection between the UE 150 and the AR glasses 140 may be a Wi-Fi channel. The UE 150 may operate as a bridge between the two channels and resources, receiving downlink 210 on the radio channel and transmitting downlink 211 on the Wi-Fi channel. Any mismatch in timing between the downlink 210 and the downlink 211 may be buffered in memory on the UE 150 as buffered delay 215. The downlink 210 may be transmitted according to the resource allocation of the radio channel and the downlink 211 may be transmitted according to the target wake time (TWT) of the Wi-Fi channel allocated to the AR glasses 140.

The TWT may define a TWT window by a TWT start time and the TWT interval. In some embodiments, the TWT interval and TWT start may be set based on a discontinuous reception (DRX) cycle and a DRX offset of the UE, respectively, which may be configured by the network node, such as a gNB. In some embodiments, a TWT minimum wake duration may be set based on the jitter of arrival time of periodic data traffic that is received by the UE.

The allocation of PDSCH resources may be controlled by a physical downlink control channel (PDCCH) which may grant slots for download to various UEs sharing the PDSCH resources. The PDCCH may carry downlink control information (DCI). In the example of FIG. 2A, the PDSCH channel is broken into resource blocks which may be symbols or slots. The channel may include download blocks (D), upload blocks (U), and start blocks (S). The resource blocks (e.g., slots, frames, symbols) may be defined according to 5G protocols or similar radio network protocols. The TWT window for communication between the UE 150 and the AR glasses 140 may be defined by a Wi-Fi protocol (e.g., IEEE 802.11ax, Wi-Fi 6/6e) and may be a negotiated period allocated by the UE 150 or the AR glasses 140 or transceivers thereof. Various aspects of this timing may be implemented via a transceiver and one or more processors executing computer readable instructions.

FIG. 2B is a communications timing diagram for an uplink from AR glasses 140 to a network node 120. With reference to FIGS. 1A-2B, the data communicated in the uplink may originate at the AR glasses 140 or components thereof (e.g., imagers, inertial measurement units, clocks). The connection between the AR glasses 140 and the UE 150 may be a Wi-Fi channel. The connection between the UE 150 and the network node 120 may be a radio channel and may be a physical uplink shared channel (PUSCH) or similar uplink shared channel (e.g., LTE downlink shared channel—UL-SCH). The UE 150 may operate as a bridge between the two channels and resources, the receiving uplink 220 on the Wi-Fi channel and transmitting the uplink data to the network node 120 on the radio channel. Any mismatch in timing between the uplink 220 and the subsequent uplink 222 transfer on the radio channel (e.g., radio link 125) may be buffered in memory on the UE 150 as buffered delay 221. The uplink 220 may be transmitted according to the target wake time (TWT) of the Wi-Fi channel allocated to the AR glasses 140.

The allocation of physical uplink shared channel (PUSCH) resources may be controlled by a physical uplink control channel (PUCCH), which may grant slots for upload to a network node 120 delivering the PUSCH resources. The PUCCH may carry uplink control information (UCI). In the example of FIG. 2B, the PUSCH channel is broken into resource blocks which may be symbols or slots. The channel may include download blocks (D), upload blocks (U), and start blocks (S). The resource blocks (e.g., slots, frames, symbols) may be defined according to 5G protocols or similar radio network protocols. The TWT window for communication between the UE 150 and the AR glasses 140 may be defined by the Wi-Fi protocol (e.g., IEEE 802.11ax, Wi-Fi 6/6e) and may be a negotiated period allocated by the UE 150 or the AR glasses 140 or transceivers thereof. Various aspects of this timing may be implemented via a transceiver and one or more processors executing computer readable instructions.

The configuration of resources on the radio channel may be accomplished using radio resource control (RRC) messages from one or more UEs 150 that request slots or resources from the network node 120. In addition, the UEs 150 may transmit time sensitive communication assistance information (TSCAI) messages to the network node 120 to assist the network node 120 in appropriately allocating resources. As illustrated in FIG. 2B, in order for a UE 150 to receive a granted slot (or portion thereof), the UE 150 may first send a scheduling request (SR) in an uplink period requesting some resources in a future period (dynamic grant process). In a future period, the UE 150 may send a buffer status report (BSR) indicating the amount of data to be sent and requesting resources to do so. Finally, the UE 150 may be granted an upload resource during which the buffered data may be uploaded or transmitted. This scheduling process may introduce latency that may be too excessive for AR/XR purposes. The buffered delays 215 and 221 illustrated in FIGS. 2A and 2B are example latencies and may be larger or smaller depending on resource demand. In some implementations, the upload slot granted may be pre-configured or scheduled as a part of the PUSCH scheduling by the network node 120.

For the Wi-Fi link 145 the power saving operation may be based on a target wake time (TWT). To initialize a TWT, the user device may perform a TWT setup with the access point and receive a confirmation. Then according to a scheduled TWT start, the TWT period will continue for a TWT wake duration. In the context of extended reality, pose information related to an orientation of the user device may first be sent to the access point and ultimately to a server. The server (e.g., XR server 110) may generate video, overlays, or other audiovisual and may transmit the data back to the user device within the TWT wake duration. After the TWT wake duration, the UE may switch off the Wi-Fi transmitter and pause Wi-Fi transmit and/or receive during an OFF period. The OFF period together with the ON period (TWT) may be defined as a TWT interval. For example, a TWT interval may be 20 ms with 10-11 ms of ON time. When the user device disconnects, the TWT scheduling may be torn down and the resources freed up the access point.

In some instances, a user device may have a minimum TWT wake duration such that even if the device itself has nothing to transmit the device will remain awake to receive downlink signals. Peer devices may be informed of the minimum TWT wake duration so that they can schedule transmissions to the user device in that period. For example, tracking frames from the AR glasses 140 may aggregate for upload and send together with pose information at a beginning of a TWT or may send after download a video from the server at an end of the TWT. A download or downlink transmission opportunity may start within the TWT wake duration.

The Wi-Fi TWT scheduling allows the AR glasses 140 to enter sleep mode with a deterministic on-off duty cycle such that availability the transceiver is predictable. For example, downlink traffic may only sent within the TWT window and if downlink signals arrive outside the TWT window, they must be buffered somewhere until the next TWT window. That is, the TWT window may relate to reception (Rx) much like DRX mode relates to reception. For upload traffic, the Wi-Fi transceiver may transmit whenever available. This, however, does come at an extra power cost. Therefore, for applications using Wi-Fi regularly, power savings may be found by synchronizing or aligning processing for upload with TWT windows. Likewise, aligning uplink and downlink traffic to have the same frequency and phase may result in power savings as the transceiver may accomplished both at the same time, in the same TWT window.

In general, the system and processes disclosed herein involve coordination and information sharing across protocols (e.g., wireless protocols—Wi-Fi, 5G) and across devices. In various implementations, this coordination may be performed by a cross-layer application programmable interface (API) that may control or inform one or more layers of the 5G protocol on one or more devices and may control or inform one or more layers of the Wi-Fi protocol on one or more devices. For example, the cross-layer API may be configured to operate on the AR glasses 140 and the UE 150. In various implementations, the coordination may be performed via enhanced messaging throughout the architecture or performed by inserting additional information into resource requests and timing negotiations so as to inform devices in the architecture of the time constraints of other devices (e.g., TWT window, pose generation, etc.). Accordingly, 5G and Wi-Fi resources may be aligned for various links in the architecture.

For downlink traffic, TWT schedule timings (e.g., start, interval) for the Wi-Fi link 145 may be aligned/scheduled based on the DRX cycle configuration, the PDSCH burst traffic pattern, or semi-persistent scheduling (SPS) of the radio link 125 (e.g., 5G resources). For example, the TWT interval may be set based on the DRX cycle or the TWT start may be set based on the DRX offset. For uplink traffic, PUSCH resource timings of the radio link 125 (e.g., pre-scheduling, configured grant, dynamic grant) may be aligned/scheduled based on uplink traffic timing (e.g., pose, camera, application) or TWT window timings (e.g., start, interval, minimum duration) in the Wi-Fi link 145. For example, the configured grant periodicity of the radio link 125 may be set based on the TWT interval or a configured grant offset may be set based on the TWT start. As a part of this coordination, different clocks in the different protocols (e.g., 5G, Wi-Fi, AP) may be synchronized or clock drifts between them may be compensated for by the cross-layer API. The cross-layer API may be hosted on the UE 150 since the UE 150 accesses the radio link 125 and the Wi-Fi link 145.

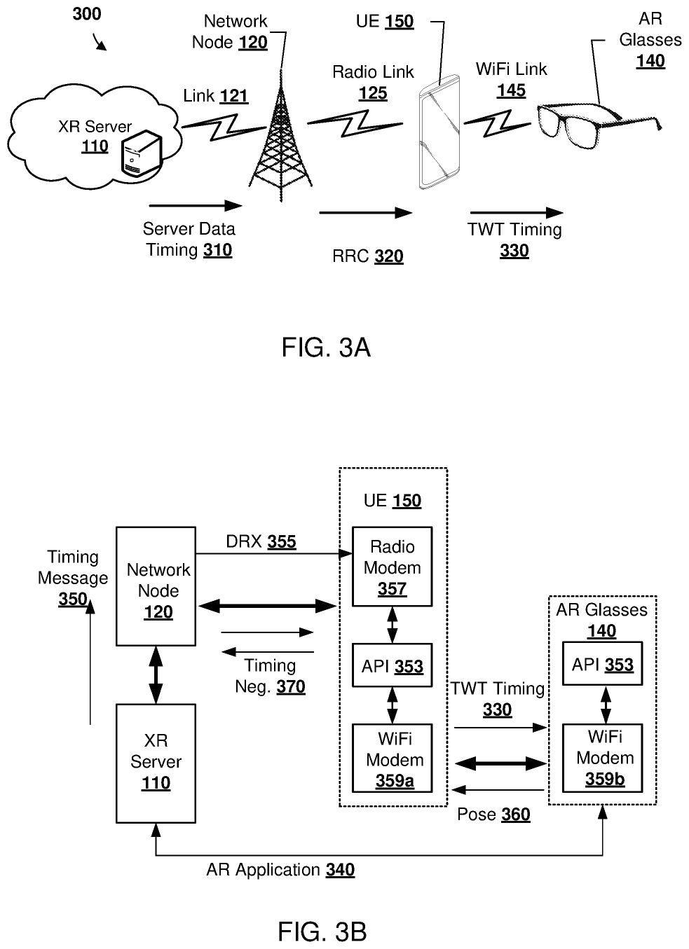

FIG. 3A is a network flow diagram illustrating a phone-to-glass split augmented reality architecture 300. FIG. 3B is a component block diagram illustrating information flows between various components in a phone-to-glass split augmented reality system. With reference to FIGS. 1A-3B, in the consumer augmented reality space, the phone-to-glass (P2G) architecture relates to a system in which a phone relays extended reality traffic between the XR server 110 and the AR glasses 140 using 5G and Wi-Fi links. For example, the AR glasses 140 illustrated require only Wi-Fi conductivity which may reduce product size, weight, cost, and power consumption. The phone may provide better 5G connectivity with its larger form factor and antenna size than could the AR glasses. Additionally, the AR glasses can help save power in a long-distance scenario since the long leg of the uplink traffic would be handled by the phone. Thus, the phone-to-glass architecture may combine two separate wireless protocols for better results.

This phone to glass architecture with split protocols may have resource timings in the 5G and Wi-Fi resources that are not aligned or operate without coordination. In part, the system disclosed herein provides processes and components for such coordination. For example, a key power saving feature of communication is the discontinuous reception (DRX) cycle which cycles a transceiver's receiving and decoding on and off in order to save power. Likewise, in the Wi-Fi communication protocol a device may be assigned a target wake time (TWT) during which the device may transmit and receive. When a 5G device or a Wi-Fi device is in a power save mode, uplink or downlink to or through the device may not be possible. When one uplink or downlink in the chain of this architecture is not possible or delayed, latency and degraded service occur.

In the examples illustrated in FIG. 3A and FIG. 3B, the timing coordination is driven by the XR server 110. That is, after an initialization between the extended reality application on the AR glasses 140 and the XR processing application on the XR server 110, the server 110 may drive the timing of data uploads, downloads, rendering, and other aspects of the AR experience on the glasses. In FIG. 3A, XR server 110 may transmit server data timing 310 to network node 120. The network node 120 may use this timing information to configure a DRX period for the UE 150. The network node 120 may inform the UE 150 of the new DRX timing via the radio resource control (RRC) message 320 or via the PDCCH/PUCCH of the radio link 125. The UE 150 may be prepared to receive data from the XR server 110 when it has been processed. Based on the DRX cycle, the UE 150 may establish or negotiate a TWT timing 330 for the AR glasses 140. Various example processes in this coordination are illustrated in more detail in FIG. 3B.

The AR application 340 may be adapted to split processes between the XR server 110 and the AR glasses 140. At start up, the AR application 340 will make contact with the XR server 110 in which this initial contact may be made via the split architecture of FIG. 3A but may be uncoordinated. The XR server 110 may decide a traffic offset or burst traffic offset for media generated at the XR server 110. The network node 120 or the core network 180 may determine the burst traffic offset. The traffic offset or burst traffic offset may be determined such that the traffic from the XR server 110 is scheduled to be sent when the transmission resources (e.g., 5G and Wi-Fi) are available. The burst traffic offset calculated at the XR server 110 may be transmitted to network node 120, via timing message 350, and to UE 150 to inform and drive the resource allocation in the communication chain. Accordingly, the XR server 110 may initialize and guide the resource allocation within network 300 based on graphics rendering timing and traffic offsets.

The XR server 110 may transmit or confirm the burst traffic offset or the burst traffic arrival time to the network node 120. The transmission, confirmation, or negotiation of the traffic offset may be performed via enhanced TSCAI messages exchanged between the XR server 110 and the network node 120. Based on the burst traffic offset (e.g., server data timing 310), the network node 120 may reconfigure or adjust a DRX configuration or radio resources via an RRC reconfiguration 320. The RRC reconfiguration 320 configures the radio resources of the radio link 125. The RRC reconfiguration 320 or the enhanced TSCAI messages may inform the UE 150 of a transmission timing carrying XR data. The UE 150 may negotiate or establish the Wi-Fi TWT schedule based on the radio resources assigned by the RRC reconfiguration 320 (e.g., DRX cycle). That is, the UE 150 may drive Wi-Fi scheduling and timing for the AR glasses 140 based on the server timing.

The UE 150 may include an API 353 which may communicate with the radio modem 357 and the Wi-Fi modem 359a which are on the UE 150. API 353 may determine or receive any information from the radio modem 357 and translate or relay that information across one or more layers and across protocols (e.g., 5G, Wi-Fi). The Wi-Fi modem 359a may receive suggested or proposed TWT timing 330 for the TWT window and inform the corresponding Wi-Fi modem 359b of the AR glasses 140 of such timing. The AR glasses 140 may also operate (execute) at least a portion of an API 353 to manage the timing alignment and offsets together with its counterpart in the UE 150. The API 353 in one or more user devices (e.g., UE 150, AR glasses 140) may connect via various modems and transceivers to align or synchronize operations (e.g., device data transmissions).

The UE 150 may align or schedule the TWT to coincide with a DRX connected period (e.g., transceiver ON) or other DRX parameters (e.g., cycle, offset, configuration). The UE 150 (e.g., cellphone) or the API 353 on either the UE 150 or the AR glasses 140 may set or establish the TWT timing 330 under the control of the UE 150. Based on the aligned TWT and DRX, the AR glasses may upload pose information 360 based on the TWT. For example, the pose 360 may be uploaded at a beginning of the TWT so that the AR glasses 140 have the remainder of the TWT period to await the XR data from the XR server 110. The UE 150 or the API 353 on either the UE 150 or the AR glasses 140 may set or establish the TWT timing 330 under the control of the UE 150 such that the TWT aligns or coincides with the XR downlink traffic pattern. The timing control or negotiation between the UE 150 and the AR glasses 140 may be performed according to a timing synchronization function (TSF) of the Wi-Fi protocol and the exchange of TSF messages. The TWT timing may be updated periodically by the UE 150 when the UE 150 or AR glasses 140 detect that the TWT window has drifted by more than a threshold relative to a DRX cycle or XR downlink or other radio resource.

The alignment between the XR server 110 generating data and the receipt of that data at the UE 150 during a DRX connected period may deteriorate after being established (despite the API 353 on the UE 150 synchronizing the various clocks as noted previously). Accordingly, the UE 150 may periodically transmit UE assistance information (UAI) to the network node 120 to proactively request PUSCH/PDSCH resources for pose information 360. The network node 120 may perform a configured grant or prescheduling of radio resources for the UE 150 based on the request and/or based on server data timing 310 (e.g., timing messages 350). The proactive request by the UE 150 may be sent via a synchronization signal block (SSB) or a tracking reference signal (TRS) or other channel scheduling signal. The XR server 110 may continue to set timing (at least at the network node 120) based on its audiovisual rendering schedule and related burst traffic (e.g., burst traffic offset).

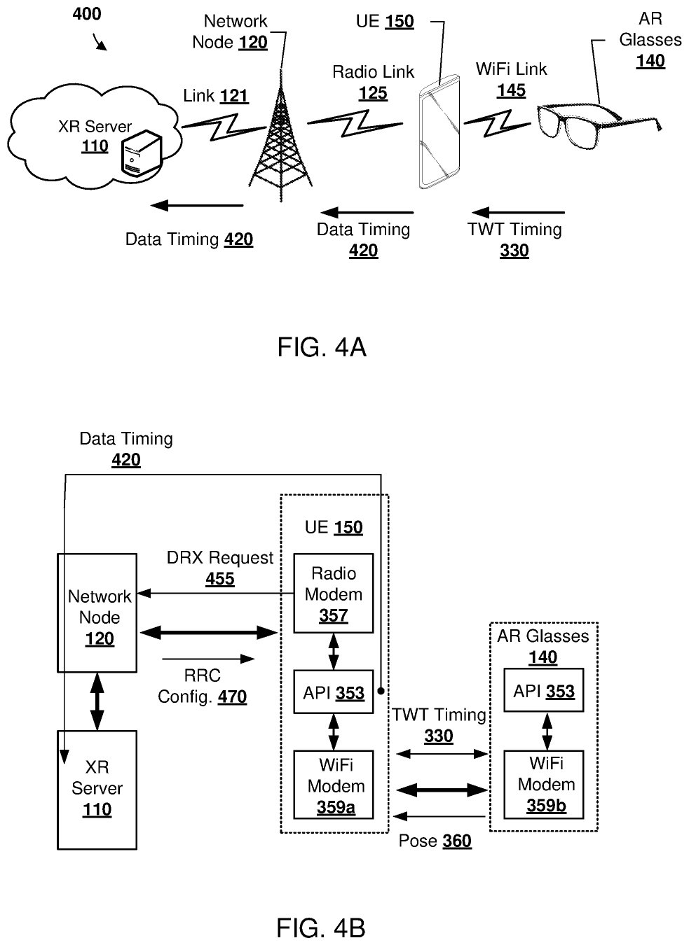

FIG. 4A illustrates a network architecture 400 according to an implementation. With reference to FIGS. 1A-4A, the phone-to-glass timing may be driven or set based on the AR glasses' generation of data such that timing control flows upstream to the XR server 110. The AR glasses 140 may set or schedule one or more target wake times (TWT) for itself and Wi-Fi link 145 and may inform UE 150 of the TWT timing 330. The UE 150 may request resources or inform the network node 120 that data is to be expected for upload during the TWT of the AR glasses 140. The network node 120 may pass on this data timing information (e.g., data timing 420) to the XR server 110 via link 121 (e.g., backhaul link). Based on this expected data timing, the XR server 110 may set a rendering schedule or may similarly inform the downstream devices (e.g., UE 150, AR glasses) when it will complete the processing of the uploaded data.

FIG. 4B illustrates this process of radio and Wi-Fi timing being set by the user device (e.g., AR glasses 140). With reference to FIGS. 1A-4B, the AR glasses 140 may generate pose information 360 at a given time or according to a given schedule. The AR glasses 140 may set the TWT start time for its Wi-Fi modem 359b so as to coincide with the generation of the pose information 360. The AR glasses may continue to drive, set, or reset the TWT start time (or other TWT parameter) as the TWT period shifts relative to the pose generation 360 (or vice versus). The API 353 may negotiate or be informed of the TWT timing 330 and may ensure that Wi-Fi modems 359a and 359b have the TWT timing 330. The API 353 may also inform the radio modem 357 of the TWT timing 330. The API 353 or the UE 150 may generate a request to the XR server 110 for an optimal render start time (e.g., data timing 420) for the audiovisual rendering corresponding to the pose information 360. The API 353 may calculate an offset or expected delay between the TWT start or the pose upload to the UE and the arrival of the pose information at the XR server 110. That is, the optimal render time may be based on the pose information generation timing or the TWT start time and may be offset from these timings due to transmission delays.

In addition to informing the XR server 110 of the optimal render time, the UE 150 may transmit a DRX request 455 or UE assistance information or the like that requests an RRC reconfiguration to update a DRX cycle of the UE 150 (or PUSCH resource allocation) to coincide with the TWT timing 330. That is, the UE 150 may inform the XR server 110 of an optimal rendering or pose processing time and may inform the network node 120 of an optimal DRX connected timing based on the information from the AR glasses 140. The network node 120 may transmit a RRC reconfiguration 470 with updated radio resources based on the UE-assistance information.

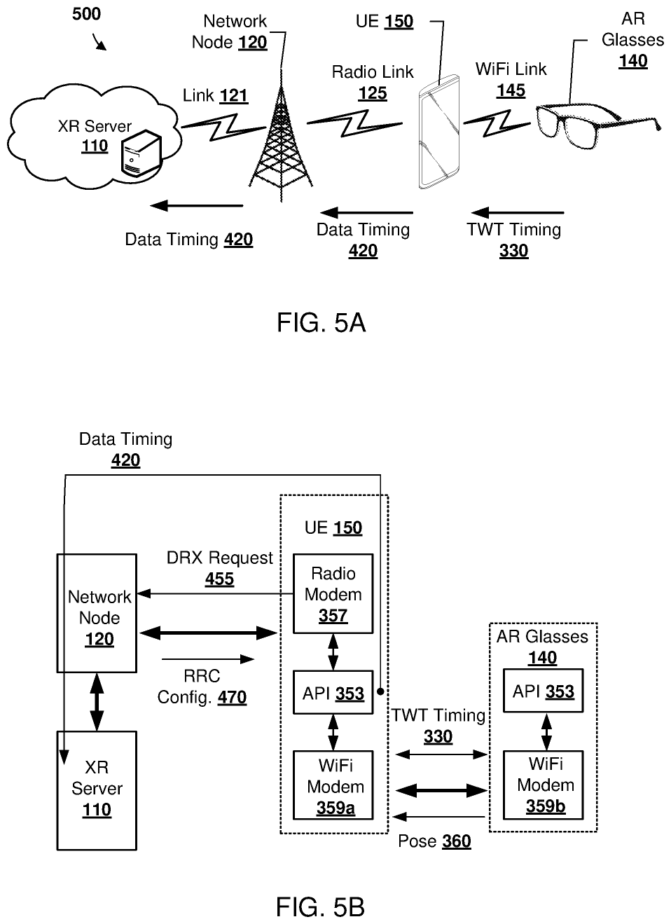

FIG. 5A illustrates a network architecture 500 according to an implementation. With reference to FIGS. 1A-5A, the phone-to-glass timing may be driven or set based on the AR glasses 140 such that timing control flows upstream to the XR server 110, similar to the architecture and message flows illustrated in FIGS. 4A-4B. Here AR glasses 140 may transmit TWT timing 330 to UE 150 which may transmit data timing 420 in the form of messages or requests to the network node 120. The network node 120 may relay the information or message the XR server 110 of the data timing 420. In this case, the key timing factor is one or more TWT parameters at the AR glasses 140 that are used to determine upstream timing.

FIG. 5B illustrates this process of radio and Wi-Fi timing being set by the user device (e.g., AR glasses 140) based on the target awake time (TWT). With reference to FIGS. 1A-5B, the TWT period (e.g., TWT start) may be set by the UE 150 or the AR glasses 140 and may be set based on broader network resource availability (e.g., mesh network, channel sharing). The AR glasses 140 may set the pose information generation time to coincide with the start of the TWT period. Since pose generation may simply involve measurement, this process may have more flexible timing constraints than the network communications. The UE 150 may request or inform the XR server 110 of the optimal render time based on the TWT start time and the expected pose information timing. The request may include requests or timing information (e.g., offsets) regarding when to optimally send the rendered audiovisual information to the network node 120 and UE 150. The UE 150 may request from the network node 120 an optimal DRX offset (or other DRX parameter) and PUSCH/PDSCH resources corresponding to the expected audiovisual transmit time or the pose information upload timing. This request may be performed via a UE assistance information (UAI) message. The network node 120 may send an RRC reconfiguration to adjust network resources based on the UAI message such that DRX, PUSCH or PDSCH correspond with downlink of the audiovisual data or uplink of the pose information. Thus, the local TWT of the AR glasses (user device) may drive the overall end-to-end timing of the network architecture 500.

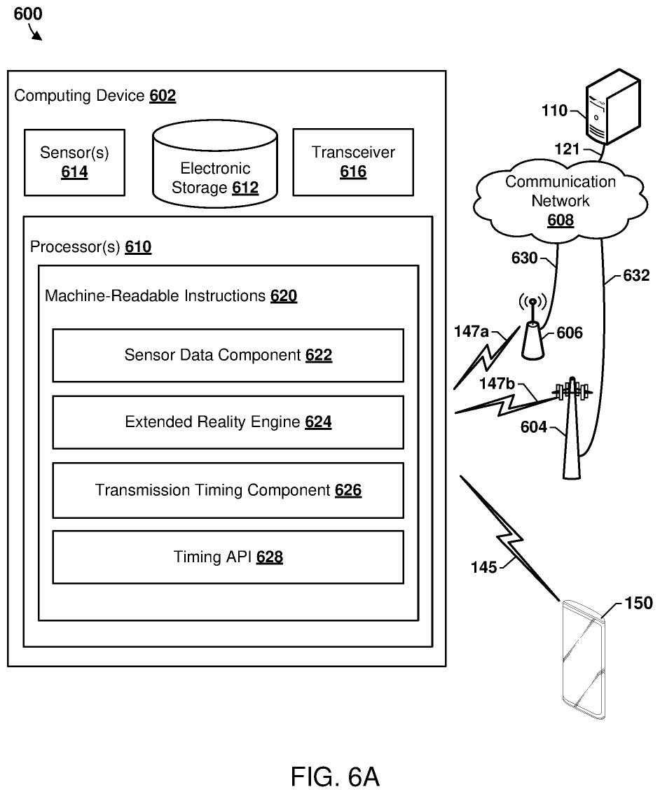

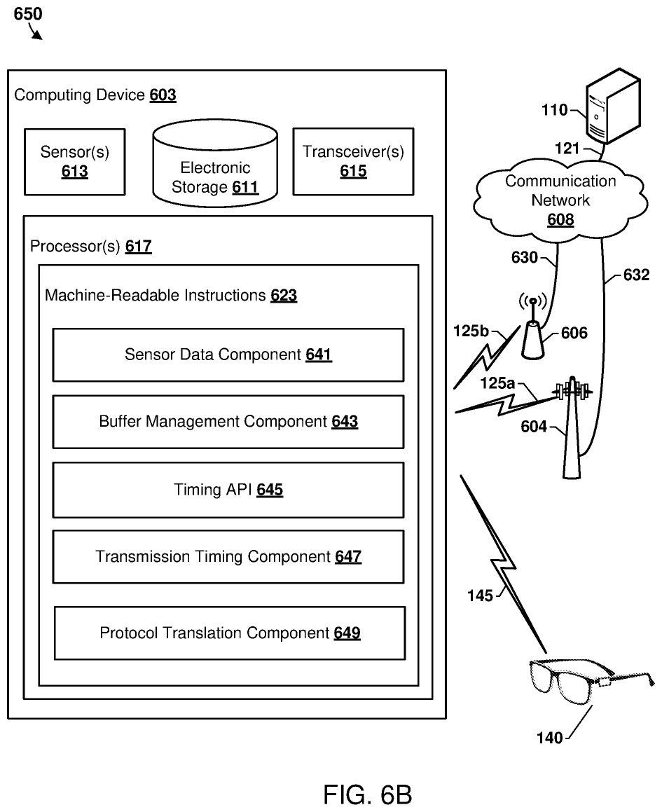

FIG. 6A is a component block diagram illustrating a system 600 configured to generate pose information and coordinate transmissions with an extended reality server (e.g., XR server 110) for an AR device in accordance with various embodiments. With reference to FIGS. 1A-6A, the system 600 may include a computing device 602 configured to communicate with one or more UEs 150 or other computing devices via a local wireless connection (e.g., Wi-Fi 145, Bluetooth, Ant, etc.) or other near field communications (NFC) techniques. The computing device 602 may also be configured to communicate with external resources (e.g., XR server 110) via a wireless connection 147a/147b to a wireless communication network 608, such as a cellular wireless communication network. Wireless connection 147a may be a radio link to picocell 606 which may connect via backhaul or midhaul 630 to communication network 608. Wireless connection 147b may be a radio link to gNB 604 which may connect via backhaul or midhaul 632 to communication network 608. The communication network may connect to XR server 110 via link 121 (e.g., fiber).

The computing device 602 may include one or more processors 610, electronic storage 612, one or more sensor(s) 614, a transceiver 616 (e.g., wireless transceiver), and other components. The computing device 602 may include communication lines, or ports to enable the exchange of information with a network and/or other computing platforms. Illustration of the computing device 602 in FIG. 6A is not intended to be limiting. The computing device 602 may include a plurality of hardware, software, and/or firmware components operating together to provide the functionality attributed herein to the computing device 602.

Electronic storage 612 may include non-transitory storage media that electronically stores information. The electronic storage media of electronic storage 612 may include one or both of system storage that is provided integrally (i.e., substantially non-removable) with the computing device 602 and/or removable storage that is removably connectable to the computing device 602 via, for example, a port (e.g., a universal serial bus (USB) port, a firewire port, etc.) or a drive (e.g., a disk drive, etc.). Electronic storage 612 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 612 may include one or more virtual storage resources (e.g., cloud storage, a virtual private network, and/or other virtual storage resources). Electronic storage 612 may store software algorithms, information determined by processor(s) 610, information received from the computing device 602, information received from UEs 150, external resources (e.g., XR server 110), and/or other information that enables the computing device 602 to function as described herein.

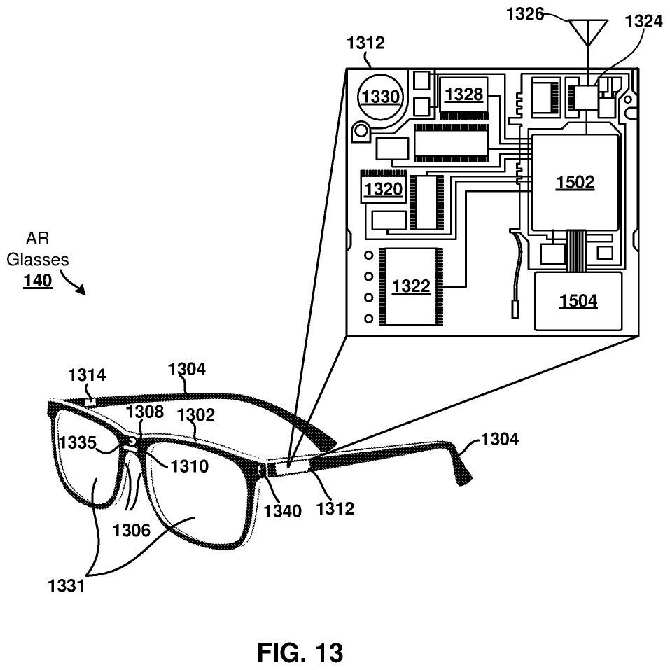

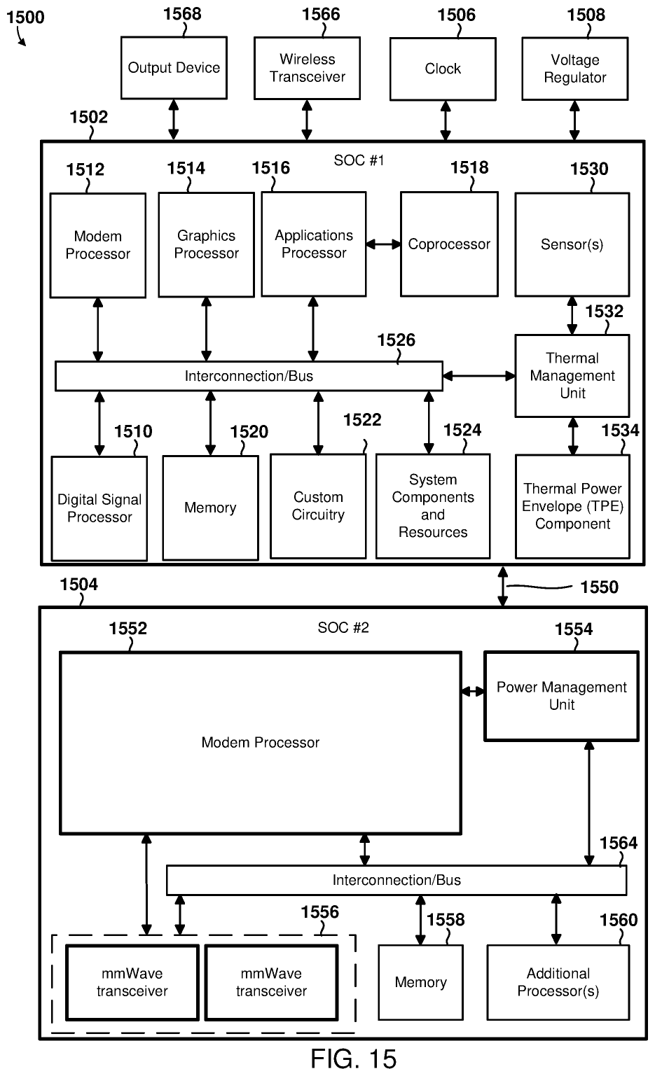

Processor(s) 610 may include one of more local processors (as described with respect to FIGS. 13 and 15), which may be configured to provide information processing capabilities in the computing device 602. As such, processor(s) 610 may include one or more of a digital processor, an analog processor, a digital circuit designed to process information, an analog circuit designed to process information, a state machine, and/or other mechanisms for electronically processing information. Although processor(s) 602 is shown in FIG. 6A as a single entity, this is for illustrative purposes only. In some embodiments, processor(s) 610 may include a plurality of processing units. These processing units may be physically located within the same device, or processor(s) 610 may represent processing functionality of a plurality of devices operating in coordination.

The computing device 602 may be configured by machine-readable instructions 620, which may include one or more instruction modules. The instruction modules may include computer program components. In particular, the instruction modules may include one or more of a sensor data component 622, an extended reality engine 624, a transmission timing component 626, a timing API 628, and/or other instruction modules. Together these components (e.g., 622-628) may provide an augmented reality experience via AR glasses 140 as also illustrated in FIG. 13.

The sensor data component 622 may connect to one or more sensors 614 to detect orientation, ranging, inertia, movement, direction, and other pose information. Ranging sensor information may come from one or more cameras, lidar, radar, sonar, laser, wireless signaling (e.g., Wi-Fi ranging), ultrasonic and/or other range finding systems. Cameras and lidar using computer vision may detect the location and angular orientation of surfaces, as well as recognize objects. Inertial and orientation information may be detected by an inertial measurement unit (IMU) including accelerometers, gravitometers, and magnetometers. Direction, orientation, and movement may be detected by global positioning satellite (GPS) systems or the like. Other pose information and eye tracking data may be captured by a camera and inferred or calculated from the camera data via one or more computer models.

As a non-limiting example, the processor(s) 610 of the computing device 602 may receive sensor data directly from onboard sensors, such as the sensor(s) 614, and/or use one or more transceivers (e.g., 1324) for detecting available wireless connections (e.g., Wi-Fi, Bluetooth, cellular, etc.) and for obtaining sensor information from remote sensors. Also, the sensor data component 622 may be configured to determine whether a detected communication link is available to a UE 150 or other remote computing device (e.g., by measuring signal strength).

The extended reality (XR) engine 624 may include one or more audiovisual rendering processes to render graphics and sounds for the XR/AR experience provided by the device. The XR engine 624 may, for example, render icons indicating further information is available corresponding to real-world objects being viewed by a user via AR glasses 140. The XR engine 624 may, for example, generate and play an animal sound corresponding to an animal being viewed in a zoo through AR glasses 140.

As a non-limiting example, the processor(s) 610 of the computing device 602 may render AR/XR audiovisual information on the processors, and/or use one or more transceivers (e.g., 1324) to manage and obtain rendered audiovisual data for provision to the user from a remote computing resource (e.g., XR server 110) based on local information (e.g., pose). The XR engine 624 may include application 340 and may initialize contact with XR server 110 and operate one or more processes of the XR engine 624 remotely on the XR server 110.

The transmission timing component 626 may measure delay on one or more links of the network (e.g., 100, 200, 300, 400, 500) based on acknowledgement/non-acknowledgement (ACK/NACK) timing, response delay, or timestamps. The transmission timing component 626 may use the delay or round-trip time to determine offsets for one or more links (e.g., Wi-Fi link 145) or optimal timings of data transmissions (e.g., burst traffic). The transmission timing component 626 may measure drift in one or more clocks of devices in the chain (e.g., UE 150) based on received timestamps or the timing synchronization function (TSF). The transmission timing component 626 may propose to a timing API 628 or one or more devices (e.g., UE 150) an update to scheduling or alignment based on a clock drift or offset.

As a non-limiting example, the processor(s) 610 of the computing device 602 may calculate timing differences via the transmission timing component 626 on the processors, and/or use one or more transceivers (e.g., 1324) to obtain ACK/NACK information and timestamps from a remote computing resource (e.g., XR server 110) or another external network device.

The timing API 628 of compute device 602 (e.g., AR glasses 140) may form a connection with a corresponding API at a UE or network device (e.g., UE 150) and may exchange messages including timing information with a corresponding API. The timing API 628 may negotiate one or more TWT periods or a TWT schedule with a Wi-Fi network together with a corresponding API in another device on the network (e.g., mesh network). The timing API 628 may receive timing information from the transmission timing component 626 and coordinate changes to network resources of external devices based on the received timing information.

As a non-limiting example, the processor(s) 610 of the computing device 602 may execute the timing API 628 on the processors, and/or use one or more transceivers (e.g., 1324) to connect corresponding APIs of a UE (e.g., UE 150) or other external network devices. The processor(s) 610 of the computing device 602 may execute the timing API 628 to provide an available interface for coordination with one or more external devices and one or more Wi-Fi resource controllers.

FIG. 6B is a component block diagram illustrating a system 650 configured to coordinate and translate transmissions between an AR device and a communication network in accordance with various embodiments. With reference to FIGS. 1A-6B, the system 650 may include a computing device 603 configured to communicate with one or more AR glasses 140 or other computing devices via a local wireless connection (e.g., Wi-Fi 145, Bluetooth, Ant, etc.) or other NFC communication techniques. The computing device 603 may also be configured to communicate with external resources (e.g., XR server 110) via a wireless connection 125a/125b to a wireless communication network 608, such as a cellular wireless communication network. Wireless connection 125b may be a radio link to picocell 606 which may connect via backhaul or midhaul 630 to communication network 608. Wireless connection 125a may be a radio link to gNB 604 which may connect via backhaul or midhaul 632 to communication network 608. The communication network 608 may connect to XR server 110 via link 121 (e.g., fiber).

The computing device 603 may include one or more processors 617, electronic storage 611, one or more sensor(s) 613, a transceiver 615 (e.g., wireless transceiver), and other components. The computing device 603 may include communication lines, or ports to enable the exchange of information with a network and/or other computing platforms. Illustration of the computing device 603 in FIG. 6B is not intended to be limiting. The computing device 603 may include a plurality of hardware, software, and/or firmware components operating together to provide the functionality attributed herein to the computing device 603.

Electronic storage 611 may include non-transitory storage media that electronically stores information. The electronic storage media of electronic storage 611 may include one or both of system storage that is provided integrally (i.e., substantially non-removable) with the computing device 603 and/or removable storage that is removably connectable to the computing device 603 via, for example, a port (e.g., a universal serial bus (USB) port, a firewire port, etc.) or a drive (e.g., a disk drive, etc.). Electronic storage 611 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 611 may include one or more virtual storage resources (e.g., cloud storage, a virtual private network, and/or other virtual storage resources). Electronic storage 611 may store software algorithms, information determined by processor(s) 617, information received from the computing device 603, information received from AR glasses 140, external resources (e.g., XR server 110), and/or other information that enables the computing device 603 to function as described herein.

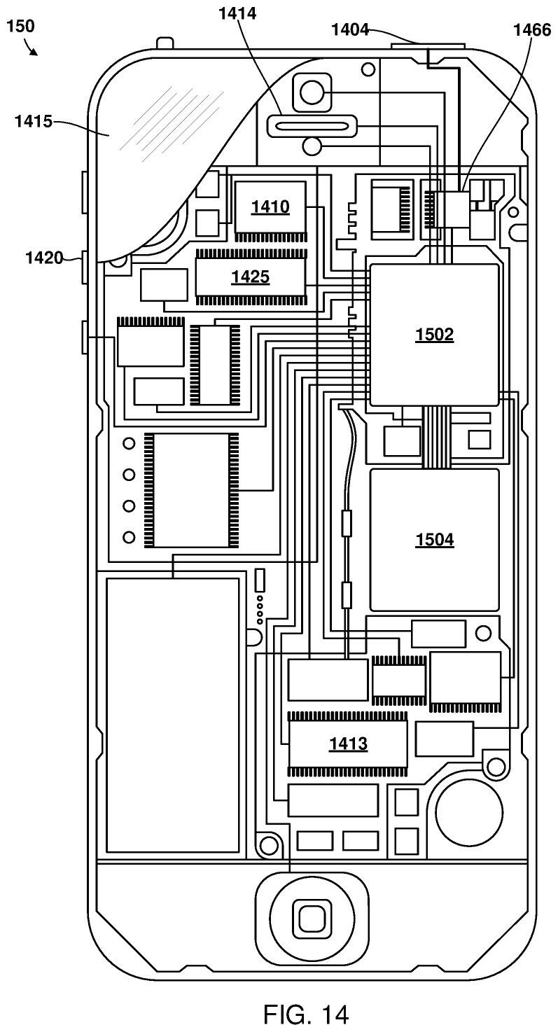

Processor(s) 617 may include one of more local processors (as described with respect to FIGS. 14 and 15), which may be configured to provide information processing capabilities in the computing device 603. As such, processor(s) 617 may include one or more of a digital processor, an analog processor, a digital circuit designed to process information, an analog circuit designed to process information, a state machine, and/or other mechanisms for electronically processing information. Although processor(s) 603 is shown in FIG. 6B as a single entity, this is for illustrative purposes only. In some embodiments, processor(s) 617 may include a plurality of processing units. These processing units may be physically located within the same device, or processor(s) 617 may represent processing functionality of a plurality of devices operating in coordination.

The computing device 603 may be configured by machine-readable instructions 623, which may include one or more instruction modules. The instruction modules may include computer program components. In particular, the instruction modules may include one or more of a sensor data component 641, a buffer management component 643, a transmission timing component 647, a timing API 645, a protocol translation component 649, and/or other instruction components. Together these components (e.g., 641-649) of computing device 603 may provide a synchronized relay for an augmented reality device.

The sensor data component 641 may connect to one or more sensors 613 including global positioning system (GPS) components, IMUs, time of flight (TOF) or round-trip time (RRT) sensors, and other sensors. The sensor data component 641 may include processes for data collection from sensors 613 and may store this data on electronic storage 611.

As a non-limiting example, the processor(s) 617 of the computing device 603 may operate the sensor data component 641 on the processors, and/or use one or more transceivers (e.g., 1466) to connect to remote sensors or other external network devices. The processor(s) 617 of the computing device 603 may execute the sensor data component 641 to obtain timing, location, and quality of service measurements for a local device and one or more external devices.

The buffer management component 643 reserve or manage one or more blocks of memory of electronic storage 611. The buffer management component 643 may record latency of data stored therein (e.g., buffered latency 215) and may reorder or sort data stored therein for optimal transmission timing and quality of service. The buffer management component 643 may connect to a local Wi-Fi transceiver, a local radio transceiver, the timing API 645, the protocol translation component 649, and other components. The buffer management component 643 may operate a buffer that is a part of electronic storage 611 so as to receive uplink or downlink data and store it at least until a corresponding window of transmission on the next link begins.

As a non-limiting example, the processor(s) 617 of the computing device 603 may operate the buffer management component 643 on the processors, and/or use one or more transceivers (e.g., 1466) offload data in the buffer to remote resources, destination devices, or other external network devices. The processor(s) 617 of the computing device 603 may execute the buffer management component 643 to manage the storage of data received at one transceiver and not yet ready to be transmitted on another one or retransmitted.

The timing API 645 of compute device 603 may form a connection with a corresponding API at an AR device or network device and may exchange messages including timing information with a corresponding API. The timing API 645 may negotiate one or more TWT periods or a TWT schedule with a Wi-Fi network together with a corresponding API in another device on the network (e.g., mesh network). The timing API 645 may negotiate one or more DRX periods or configured grant slots with a radio network via a radio modem. The timing API 645 may receive timing information from the transmission timing component 647 and coordinate changes to network resources of external devices based on the received timing information.

As a non-limiting example, the processor(s) 617 of the computing device 602 may execute the timing API 645 on the processors, and/or use one or more transceivers (e.g., 1466) to connect corresponding APIs of an AR device or other external network devices. The processor(s) 617 of the computing device 603 may execute the timing API 645 to provide an available interface for coordination with one or more external devices, one or more Wi-Fi resource controllers, and one or more radio resource controllers.

The transmission timing component 647 may measure delay on one or more links of the network (e.g., 100, 200, 300, 400, 500) based on acknowledgement/non-acknowledgement (ACK/NACK) timing, response delay, or timestamps. The transmission timing component 647 may use the delay or round-trip time to determine offsets for one or more links (e.g., Wi-Fi link 145) or optimal timings of data transmissions (e.g., burst traffic). The transmission timing component 647 may measure drift in one or more clocks of devices in the chain (e.g., AR glasses 140) based on received timestamps, TSF messages, SSB/TRS messages, or TSCAI messages. The transmission timing component 647 may propose to a timing API 645 or one or more devices (e.g., AR glasses 140) an update to scheduling or alignment based on a clock drift or offset.

As a non-limiting example, the processor(s) 617 of the computing device 603 may calculate timing differences via the transmission timing component 647 on the processors, and/or use one or more transceivers (e.g., 1466) to obtain ACK/NACK information and timestamps from a remote computing resource (e.g., XR server 110) or another external network device.

The protocol translation component 649 may unpack one or more layers of a first protocol (e.g., Wi-Fi) and re-package the underlying data with layers of a second protocol (e.g., 5G). The protocol translation component 649 may translate or wrap packets from one protocol into a compatible format of another protocol or may re-package payloads of one or more packets for transmission. Other package relay operations may be performed by the protocol translation component 649 so as to ensure seamless transfer of data from radio transmission protocols (e.g., 5G) to Wi-Fi transmission protocols (e.g., 802.11ax).

As a non-limiting example, the processor(s) 617 of the computing device 603 may execute the protocol translation component 649 on the processors, and/or use one or more transceivers (e.g., 1466) to relay the translated data.

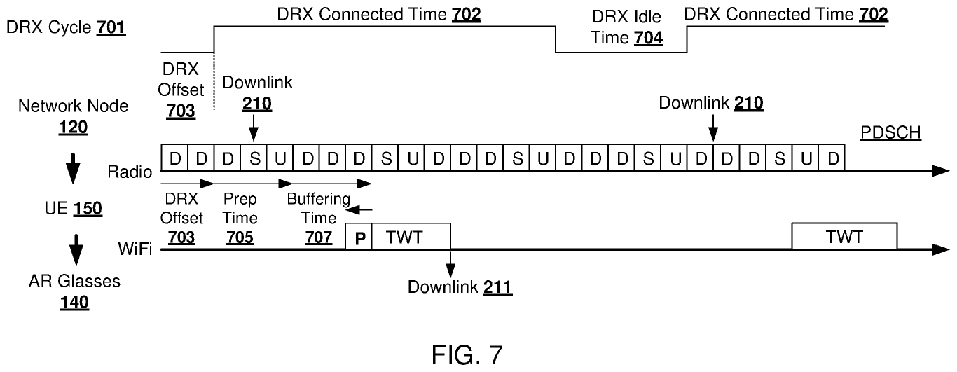

FIG. 7 illustrates a timing diagram of network resources of various network links in an aligned configuration according to an implementation. With reference to FIGS. 1A-7, the timing diagram in FIG. 7 may relate to a downlink of video frames or audiovisual data from a XR server 110 through network node 120 to UE 150 and on to a user device in the form of AR glasses 140 for display. The downlink 210 signals or data from the XR server 110 may be aligned with a DRX offset 703 such that the DRX cycle 701 is in a DRX connected time 702. The downlink 210 signals or data from the XR server 110 may be timed to coincide with the DRX connected time 702 of the PDSCH rather than the DRX idle time 704. Upon receipt of the downlink 210 by the network node 120, the network node 120 may perform various channel or data preparation processes during preparation time 705 before transmission to the UE 150. The UE 150 may use preparation time 705 to receive the first packet from gNB (e.g. channel status report) and may store or buffer the data for a buffering time 707 until the AR glasses 140 are ready to receive in a TWT (e.g., after pose information upload). If the data rate of the Wi-Fi link is faster than the 5G link, AR glasses using the Wi-Fi link does not need to wake up until a sufficient amount of data is buffered in the UE. So, the buffering time 707 can allow the Wi-Fi transceiver of the AR glasses to remain in the sleep mode longer, thus saving power. Also, this buffering time 707 may include a glasses-to-phone offset (shown as a reverse arrow) within a TWT of the AR glasses 140 that corresponds to an upload period for the pose information if the pose information is transmitted before the TWT. Once the AR glasses 140 are ready to receive in a TWT window, the UE 150 may transmit downlink 211 to the AR glasses 140. This process may be repeated as illustrated in the next DRX connected time 702. The alignment may be performed by AR glasses 140 aligning a TWT with a DRX offset 703 or other parameter plus preparation time 705 and buffering time 707.

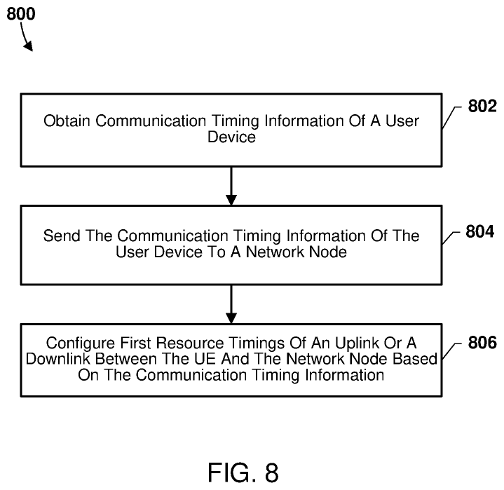

FIG. 8 is a process flow diagram illustrating an example method 800 for adjusting communication resources of a device. With reference to FIGS. 1A-8, in block 802, a UE 150 (or processor/transceiver thereof) may obtain communication timing information of a user device (e.g., AR glasses 140). Means for performing the operations of block 802 may include a processor (e.g., 1322, 1425, 1502, 1504, 1552) coupled to memory (e.g., 611, 612, 1413) or from a remote source, such as a remote system or external resources (e.g., an XR server 110) using a transceiver (e.g., 1324, 1466) and related components.

In block 804, the UE 150 (or processor/transceiver thereof) may send the communication timing information of the user device to a network node (e.g., network node 120). Means for performing the operations of block 804 may include a processor (e.g., 1322, 1425, 1502, 1504, 1552) coupled to memory (e.g., 611, 612, 1413) or from a remote source, such as a remote system or external resources (e.g., an XR server 110) using a transceiver (e.g., 1324, 1466) and related components.

In block 806, the UE 150 (or processor/transceiver thereof) may configure first resource timings of an uplink or a downlink between the UE and the network node based on the communication timing information. Means for performing the operations of block 806 may include a processor (e.g., 1322, 1425, 1502, 1504, 1552) coupled to memory (e.g., 611, 612, 1413) or from a remote source, such as a remote system or external resources (e.g., an XR server 110) using a transceiver (e.g., 1324, 1466) and related components.

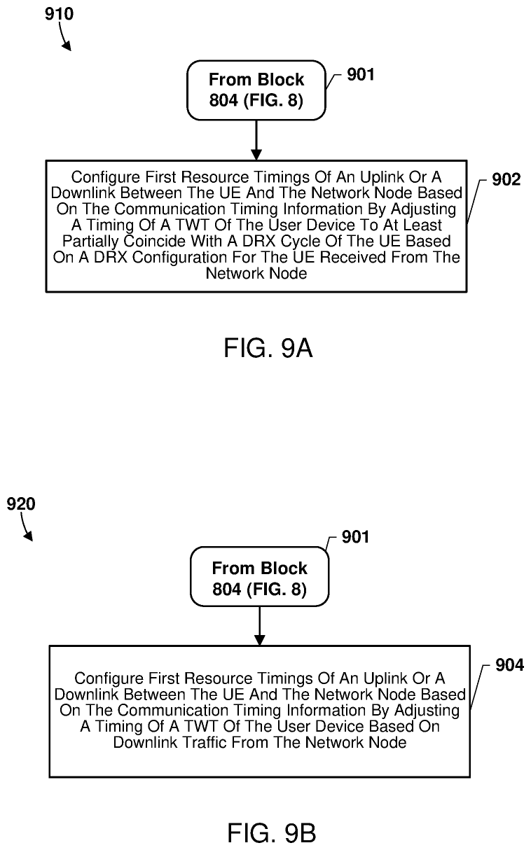

FIG. 9A is a process flow diagram illustrating an example method 910 for adjusting communication resources such that they coincide. With reference to FIGS. 1A-9A, following the operations in block 804 of the method 800, the UE 150 (or processor/transceiver thereof) may configure first resource timings of an uplink or a downlink between the UE and the network node based on the communication timing information by adjusting a timing of a TWT of the user device to at least partially coincide with a DRX cycle of the UE based on a DRX configuration for the UE received from the network node in block 901. In some embodiments, adjusting the timing of the TWT of the user device in block 902 may include setting a TWT interval and a TWT start based on a DRX cycle and a DRX offset of the UE, respectively. The DRX cycle and the DRX offset may be configured by the network node. In some embodiments, adjusting the timing of the TWT of the user device in block 902 may include setting a TWT minimum wake duration based on a jitter of arrival time of periodic data traffic received by the UE. Means for performing the operations of block 902 may include a processor (e.g., 1322, 1425, 1502, 1504, 1552) coupled to memory (e.g., 611, 612, 1413) or from a remote source, such as a remote system or external resources (e.g., an XR server 110) using a transceiver (e.g., 1324, 1466) and related components.

As a part of the operations in the method 910, the UE 150 may align a TWT schedule with DRX parameters via a cross-layer API. The network node 120 may configure the optimal DRX parameters for the UE 150 by RRC message. The UE 150 may obtain or read the DRX parameters via the cross-layer API. The UE 150 may translate the DRX timings to Wi-Fi timings (e.g., including delays and offsets). The cross-layer API or UE 150 may request adjustments of a TWT schedule based on the calculated Wi-Fi timings. For example, the TWT interval may be set to a DRX cycle. If TWT interval is not aligned with data delivery cadence of XR server 110, drift may be accumulated and compensated at a certain threshold. For example, the TWT minimum wake duration may be set to more than a jitter of traffic arrival measured on the Wi-Fi link 145. A TWT start time may be set to DRX offset plus a preparation time plus a storage time (optimal buffering time) and minus a glasses-to-phone offset (see FIG. 7). The preparation time (e.g., preparation time 705) may include time for processing data before actual transmission (e.g., sounding resource signal sending, channel state information reference signal, scheduling delay, etc.). A Wi-Fi layer of the UE 150 may be instructed to set a TWT time or schedule by the cross-layer API based on the DRX parameters. An XR layer or cross-layer API of the AR glasses may receive or read the TWT schedule from the UE 150 and may generate pose information for uplink at the TWT start time.

FIG. 9B is a process flow diagram illustrating an example method 920 for adjusting TWT timing of a device. With reference to FIGS. 1A-9B, following the operations in block 804 of the method 800, the UE 150 (or processor/transceiver thereof) may configure first resource timings of an uplink or a downlink between the UE and the network node based on the communication timing information by adjusting a timing of a TWT of the user device based on downlink traffic from the network node in block 904. In some embodiments, configuring the first resource timings in block 904 may also include adjusting, for uplink traffic from the user device to the UE, a timing of at least one of a bandwidth physical uplink shared channel (PUSCH), a configure grant of the network node based on a TWT of the user device, or an assistance message from the user device. In some embodiments, configuring the first resource timings in block 904 may also include the UE proactively sending a scheduling request (SR) for the PUSCH before data is received from the user device by considering one or both of latency of the SR or latency of a buffer status report (BSR). Means for performing the operations of block 904 may include a processor (e.g., 1322, 1425, 1502, 1504, 1552) coupled to memory (e.g., 611, 612, 1413) or from a remote source, such as a remote system or external resources (e.g., an XR server 110) using a transceiver (e.g., 1324, 1466) and related components.

As a part of the method 920, the UE 150 may configure a TWT schedule based on a downlink XR data traffic pattern. For example, if the DRX parameters are not configured by the network node 120, the UE 150 may learn a XR traffic pattern and may align the TWT schedule with the XR traffic arrival time via the cross-layer API. An XR application may initialize (e.g., AR application 340) and the network node may not configure the DRX parameters for the UE. The UE may estimate the XR traffic pattern for the downlink traffic timing (e.g., via artificial intelligence learning or machine learning) including XR traffic periodicity, XR traffic arrival time offset at UE, and XR traffic arrival time jitter. One or more of these patterns may be recorded by the XR server and sent to the UE. The UE may request a XR traffic pattern from a network node. The UE may translate the XR traffic pattern timings to Wi-Fi timings including TWT interval being set to coincide with DRX cycle, the TWT start being set to coincide with a XR traffic arrival offset at the UE minus an optimal buffering time, or a TWT minimum wake duration is set to extend further than the jitter in XR traffic arrival time. The UE may request the TWT timings of AR glasses be set via the cross-layer API based on the DRX timings or traffic timings. The UE may set the TWT schedule or TWT timings and the AR glasses may read or receive the TWT schedule and may generate pose information for uplink at the TWT start time.

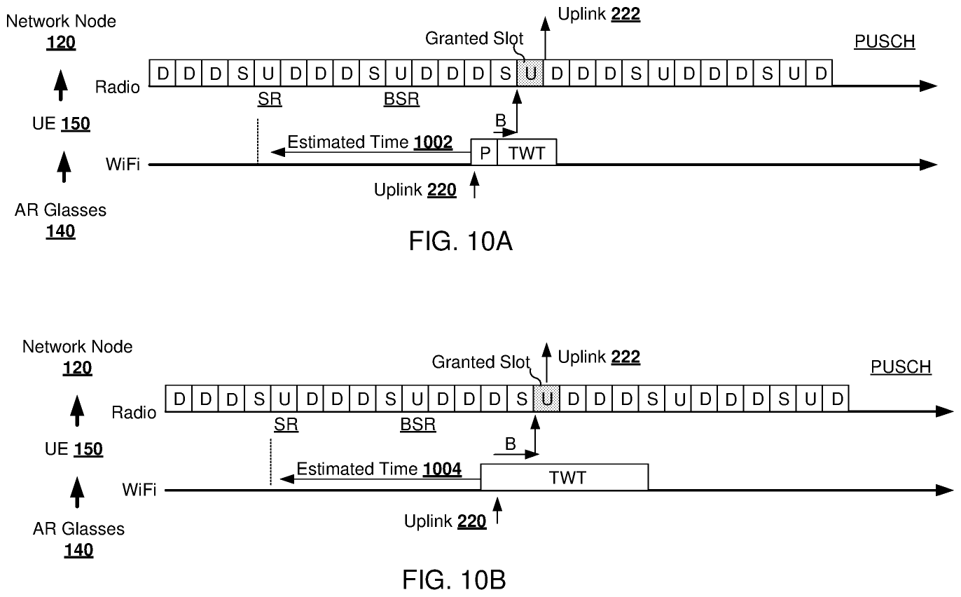

FIG. 10A illustrates a timing diagram of network resources of various network links in an aligned configuration according to an implementation. With reference to FIGS. 1A-10A, the timing diagram in FIG. 10A may relate to an uplink of data from a pair of AR glasses 140 to UE 150 and on to network node 120 and an XR server 110 (see FIG. 3A, 4A, 5A). The uplink 220 may carry pose information (P) or camera images, for example. The UE 150 may estimate time 1002 to be the time needed to complete a SR request and a BSR request and obtain a granted slot for upload in the PUSCH channel. The UE 150 may send the SR and BSR before uplink 220 has arrived. After uplink 220 has arrived, the data may be buffered (B) briefly before UE 150 transmits the data over the radio channel in the granted slot as uplink 222.

FIG. 10B illustrates a timing diagram of network resources of various network links in an aligned configuration according to an implementation. With reference to FIGS. 1A-10B, the timing diagram in FIG. 10B may relate to an uplink of data from a pair of AR glasses 140 to UE 150 and on to network node 120 and an XR server 110 (see FIG. 3A, 4A, 5A). The AR glasses 140 may indicate the traffic timing of uplink data to the UE 150 including traffic volume, traffic timing offset, and traffic periodicity. The UE 150 may estimate an estimated time 1004 needed to complete SR, BSR, and receive a granted slot (U) of PUSCH resources. The UE 150 may send SR and BSR before uplink 220 has arrived at the UE 150. The UE 150 may upload the data via uplink 222 after a relay latency (B) at the UE 150. Accordingly, the TWT may be aligned based on the traffic generation time at the AR glasses 140 and based on estimated time 1004.

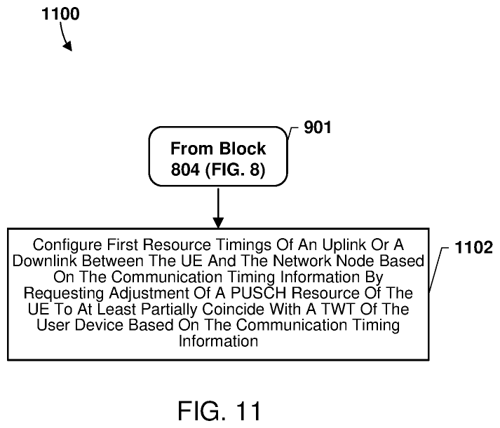

FIG. 11 is a process flow diagram illustrating an example method 1100 for adjusting a PUSCH resource.

With reference to FIGS. 1A-11, following the operations in block 804 of the method 800, the UE 150 (or processor/transceiver thereof) may configure first resource timings of an uplink or a downlink between the UE and the network node based on the communication timing information by sending a request for adjustment of a PUSCH resource of the UE to at least partially coincide with a TWT of the user device based on the communication timing information in block 1102. Means for performing the operations of block 1102 may include a processor (e.g., 1322, 1425, 1502, 1504, 1552) coupled to memory (e.g., 611, 612, 1413) or from a remote source, such as a remote system or external resources (e.g., an XR server 110) using a transceiver (e.g., 1324, 1466) and related components.

As a part of the method 1100, the UE 150 may request configuration of the PUSCH resource schedule based on the TWT schedule. For example, the UE 150 may request radio resources that coincide with receipt of an upload or uplink packet from the Wi-Fi link 145. Proactive requests by the UE 150 to align the PUSCH resources may reduce overall relay latency. The AR glasses 140 may set a pose generation timing at a TWT start time and the UE 150 may proactively reserve a PUSCH resource to coincide with the TWT timing. The UE 150 may set the TWT schedule by, for example, setting TWT start time to a DRX offset plus preparation time plus buffering time minus a glasses-to-phone (G2P) offset. The AR glasses may receive or read the TWT schedule via a cross-layer API and set pose generation timing to a TWT start time. The UE 150 may request allocation of PUSCH resources based on the glasses request or timing. An PUSCH resource timing may be scheduled based on the TWT start plus a G2P offset. For example, the UE 150 may request allocation via UE assistance information (UAI) messages for configured grant (CG) PUSCH or pre-scheduling to align slot grant with optimal uplink timing. The UE 150 may send SR and BSR in advance based on traffic information from the AR glasses 140 so that after the estimated delay from SR, BSR, and CG, the granted PUSCH resources align with the uplink timing (TWT timing).

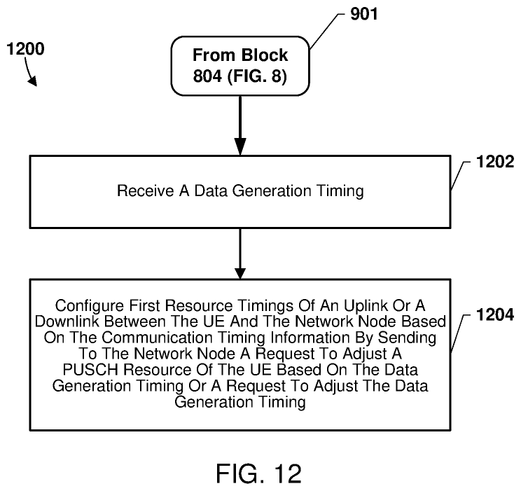

FIG. 12 is a process flow diagram illustrating an example method 1200 for adjusting XR data generation timing according to some embodiments.

With reference to FIGS. 1A-12, following the operations in block 804 of the method 800, the UE 150 (or processor/transceiver thereof) may receive a data generation timing in block 1202. Means for performing the operations of block 1202 may include a processor (e.g., 1322, 1425, 1502, 1504, 1552) coupled to memory (e.g., 611, 612, 1413) or from a remote source, such as a remote system or external resources (e.g., an XR server 110) using a transceiver (e.g., 1324, 1466) and related components.

In block 1204, the UE 150 (or processor/transceiver thereof) may configure first resource timings of an uplink or a downlink between the UE and the network node based on the communication timing information by sending to the network node a request to adjust a PUSCH resource of the UE based on the data generation timing or a request to adjust the data generation timing. Means for performing the operations of block 1204 may include a processor (e.g., 1322, 1425, 1502, 1504, 1552) coupled to memory (e.g., 611, 612, 1413) or from a remote source, such as a remote system or external resources (e.g., an XR server 110) using a transceiver (e.g., 1324, 1466) and related components.

As a part of method 1200, the XR generation timing of an XR server 110 may be adjusted based on congestion in an uplink or a downlink of a Wi-Fi link 145 between the user device (AR glasses) and the UE. The UE 150 or the AR glasses 140 may detect congestion on a Wi-Fi channel. The UE 150 or the AR glasses 140 may transmit a request to the XR server 110 via a radio uplink to adjust a data generation timing at the XR server 110. The UE 150 may designate a specific time delay in the request to the server. The XR server 110 may receive the request and move the XR data generation and hereby the XR traffic timing. The XR server 110 may update the XR traffic timing to the network node 120 via a TSCAI message. The network node 120 may update the configuration of the UE (e.g., DRX) based on the rescheduled traffic timing in the TSCAI message. Based on the DRX configuration of the UE or the XR traffic pattern, the UE 150 may update the TWT schedule of the AR glasses 140 to reduce channel congestion.

As a part of process 1200, the UE 150 may request adjustment of a PUSCH resource based on a data generation delay at the user device (AR glasses). For example, the uplink traffic periodicity may not match a downlink traffic periodicity (100 hz for pose vs. 60 hz for XR data), or server specifies pose capture timing to minimize motion-to-render delay, or the AR glasses have a camera requiring uplink traffic that has a different offset from pose uplink traffic. The AR glasses 140 may inform the UE 150 of an uplink traffic timing and the UE 150 may request PUSCH resources to correspond to the uplink traffic. The UE 150 may set the TWT schedule of the AR glasses and UE 150 to coincide with the uplink. Since this uplink traffic may not be transmitted at TWT start time, the scheduled TWT start time may not need to include G2P offset. Accordingly, the TWT start time may be set to coincide with DRX offset time plus preparation time plus buffering time. The AR glasses 140 may adjust or determine an uplink traffic (data) generation timing based on the TWT start time received via the cross-layer API. The data generation may be scheduled to fit within a TWT window or may be scheduled to upload in another TWT window (different from the TWT for pose upload). The AR glasses may send the uplink traffic to the UE 150 over the Wi-fi link 145. The AR glasses may send to the UE information regarding uplink traffic volume or uplink traffic timing offset to TWT start. If a periodicity of uplink does not match downlink periodicity, the AR glasses may indicate the uplink periodicity to the UE. If the Wi-Fi link 145 or AR glasses 140 do not specify an uplink traffic pattern, the UE 150 may learn the uplink traffic pattern of the Wi-Fi link 145 (e.g., via machine learning or artificial intelligence). The UE 150 may translate the wi-Fi uplink timing to a radio clock timing (e.g., 5G system clock). The UE 150 may proactively request allocation of PUSCH resources based on the request or information from the AR glasses (or learned information). The requested PUSCH timing may be timed based on the timing offset to TWT start plus a G2P offset.

Various embodiments (including embodiments discussed above with reference to FIGS. 8, 9A, 9B, 11 and 12) may be implemented on a variety of wearable devices, an example of which is illustrated in FIG. 13 in the form of AR glasses 140. With reference to FIGS. 1A-13, the AR glasses 140 may operate like conventional eye glasses, but with enhanced computer features and sensors, like a built-in camera 1335 and heads-up display or AR features on or near the lenses 1331. Like any glasses, smart glasses may include a frame 1302 coupled to temples 1304 that fit alongside the head and behind the ears of a wearer. The frame 1302 holds the lenses 1331 in place before the wearer's eyes when nose pads 1306 on the bridge 1308 rest on the wearer's nose.

In some embodiments, AR glasses 140 may include an image rendering device 1314 (e.g., an image projector), which may be embedded in one or both temples 1304 of the frame 1302 and configured to project images onto the optical lenses 1331. In some embodiments, the image rendering device 1314 may include a light-emitting diode (LED) module, a light tunnel, a homogenizing lens, an optical display, a fold mirror, or other components well known projectors or head-mounted displays. In some embodiments (e.g., those in which the image rendering device 1314 is not included or used), the optical lenses 1331 may be, or may include, see-through or partially see-through electronic displays. In some embodiments, the optical lenses 1331 include image-producing elements, such as see-through Organic Light-Emitting Diode (OLED) display elements or liquid crystal on silicon (LCOS) display elements. In some embodiments, the optical lenses 1331 may include independent left-eye and right-eye display elements. In some embodiments, the optical lenses 1331 may include or operate as a light guide for delivering light from the display elements to the eyes of a wearer.

The AR glasses 140 may include a number of external sensors that may be configured to obtain information about wearer actions and external conditions that may be useful for sensing images, sounds, muscle motions and other phenomenon that may be useful for detecting when the wearer is interacting with a virtual user interface as described. In some embodiments, AR glasses 140 may include a camera 1335 configured to image objects in front of the wearer in still images or a video stream, which may be transmitted to another computing device (e.g., UE 150 or XR server 110) for analysis. Additionally, the AR glasses 140 may include a lidar sensor 1340 or other ranging device. In some embodiments, the AR glasses 140 may include a microphone 1310 positioned and configured to record sounds in the vicinity of the wearer. In some embodiments, multiple microphones may be positioned in different locations on the frame 1302, such as on a distal end of the temples 1304 near the jaw, to record sounds made when a user taps a selecting object on a hand, and the like. In some embodiments, AR glasses 140 may include pressure sensors, such on the nose pads 1306, configured to sense facial movements for calibrating distance measurements. In some embodiments, AR glasses 140 may include other sensors (e.g., a thermometer, heart rate monitor, body temperature sensor, pulse oximeter, etc.) for collecting information pertaining to environment and/or user conditions that may be useful for recognizing an interaction by a user with a virtual user interface.

The processing system 1312 may include processing and communication SOCs 1502, 1504 which may include one or more processors, one or more of which may be configured with processor-executable instructions to perform operations of various embodiments. The processing and communications SOC 1502, 1504 may be coupled to internal sensors 1320, internal memory 1322, and communication circuitry 1324 coupled one or more antenna 1326 for establishing a wireless data link with an external computing device (e.g., UE 150), such as via a Bluetooth or Wi-Fi link. The processing and communication SOCs 1502, 1504 may also be coupled to sensor interface circuitry 1328 configured to control and received data from a camera 1335, microphone(s) 1310, and other sensors positioned on the frame 1302.

The internal sensors 1320 may include an IMU that includes electronic gyroscopes, accelerometers, and a magnetic compass configured to measure movements and orientation of the wearer's head. The internal sensors 1320 may further include a magnetometer, an altimeter, an odometer, and an atmospheric pressure sensor, as well as other sensors useful for determining the orientation and motions of the AR glasses 140. Such sensors may be useful in various embodiments for detecting head motions that may be used to adjust distance measurements as described. The processing system 1312 may further include a power source such as a rechargeable battery 1330 coupled to the SOCs 1502, 1504 as well as the external sensors on the frame 1302.

Various embodiments (including, but not limited to, embodiments discussed above with reference to FIGS. 1A-14) may be implemented on a variety of computing devices, an example of which is illustrated in FIG. 14 in the form of a mobile computing device (e.g., UE 150). As noted herein, the processor performing embodiment methods may be in a computing device 604 separate from the range sensor (e.g., lidar) and/or the display (e.g., AR glasses 140). With reference to FIGS. 1A-15, a mobile computing device 604 may include a first SoC 1502 (e.g., a SoC-CPU) coupled to a second SoC 1504 (e.g., a capable SoC). The first and/or second SOCs 1502, 1504 may be coupled to internal memory 1413, 1425, a display 1415, and to a speaker 1414.

Additionally, the UE 150 may include one or more antenna 1404 for sending and receiving electromagnetic radiation that may be connected to one or more wireless transceivers 1466 (e.g., a wireless data link and/or cellular transceiver, etc.) coupled to one or more processors in the first and/or second SOCs 1502, 1504. The UE 150 may also include menu selection buttons or rocker switches 1420 for receiving user inputs.

The UE 150 may additionally include a sound encoding/decoding (CODEC) circuit 1410, which digitizes sound received from a microphone into data packets suitable for wireless transmission and decodes received sound data packets to generate analog signals that are provided to the speaker to generate sound. Also, one or more of the processors in the first and/or second SOCs 1502, 1504, wireless transceiver 1466 and CODEC circuit 1410 may include a digital signal processor (DSP) circuit (not shown separately).

FIG. 15 is a component block diagram illustrating an example computing and wireless modem system 1500 suitable for implementing any of the various embodiments. Various embodiments may be implemented on a number of single processor and multiprocessor computer systems, including a system-on-chip (SOC) or system in a package (SIP).

With reference to FIGS. 1A-15, the illustrated example computing system 1500 (which may be a SIP in some embodiments) includes a two SOCs 1502, 1504 coupled to a clock 1506, a voltage regulator 1508, an output device 1568, and a wireless transceiver 1566 configured to send and receive wireless communications via an antenna (not shown) to/from a UE (e.g., 150) or a network device (e.g., 120). In some implementations, the first SOC 1502 may operate as central processing unit (CPU) of the UE that carries out the instructions of software application programs by performing the arithmetic, logical, control and input/output (I/O) operations specified by the instructions. In some implementations, the second SOC 1504 may operate as a specialized processing unit. For example, the second SOC 1504 may operate as a specialized processing unit responsible for managing high volume, high speed (such as 5 Gbps, etc.), and/or very high frequency short wavelength (such as 28 GHz mmWave spectrum, etc.) communications.

The first SOC 1502 may include a digital signal processor (DSP) 1510, a modem processor 1512, a graphics processor 1514, an application processor 1516, one or more coprocessors 1518 (such as vector co-processor) connected to one or more of the processors, memory 1520, custom circuitry 1522, system components and resources 1524, an interconnection/bus module 1526, one or more temperature sensors 1530, a thermal management unit 1532, and a thermal power envelope (TPE) component 1534. The second SOC 1504 may include a modem processor 1552, a power management unit 1554, an interconnection/bus module 1564, a plurality of mmWave transceivers 1556, memory 1558, and various additional processors 1560, such as an applications processor, packet processor, etc.

Each processor 1510, 1512, 1514, 1516, 1518, 1552, 1560 may include one or more cores, and each processor/core may perform operations independent of the other processors/cores. For example, the first SOC 1502 may include a processor that executes a first type of operating system (such as FreeBSD, LINUX, OS X, etc.) and a processor that executes a second type of operating system (such as MICROSOFT WINDOWS 10). In addition, any or all of the processors 1510, 1512, 1514, 1516, 1518, 1552, 1560 may be included as part of a processor cluster architecture (such as a synchronous processor cluster architecture, an asynchronous or heterogeneous processor cluster architecture, etc.).

The first and second SOC 1502, 1504 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 1524 of the first SOC 1502 may include power amplifiers, voltage regulators, oscillators, phase-locked loops, peripheral bridges, data controllers, memory controllers, system controllers, access ports, timers, and other similar components used to support the processors and software clients running on a UE. The system components and resources 1524 and/or custom circuitry 1522 also may include circuitry to interface with peripheral devices, such as cameras, electronic displays, wireless communication devices, external memory chips, etc.

The first and second SOC 1502, 1504 may communicate via interconnection/bus module 1550. The various processors 1510, 1512, 1514, 1516, 1518, may be interconnected to one or more memory elements 1520, system components and resources 1524, and custom circuitry 1522, and a thermal management unit 1532 via an interconnection/bus module 1526. Similarly, the processor 1552 may be interconnected to the power management unit 1554, the mmWave transceivers 1556, memory 1558, and various additional processors 1560 via the interconnection/bus module 1564. The interconnection/bus module 1526, 1550, 1564 may include an array of reconfigurable logic gates and/or implement a bus architecture (such as CoreConnect, AMBA, etc.). Communications may be provided by advanced interconnects, such as high-performance networks-on chip (NoCs).

The first and/or second SOCs 1502, 1504 may further include an input/output module (not illustrated) for communicating with resources external to the SOC, such as a clock 1506 and a voltage regulator 1508. Resources external to the SOC (such as clock 1506, voltage regulator 1508) may be shared by two or more of the internal SOC processors/cores.

In addition to the example SIP 1500 discussed above, some implementations may be implemented in a wide variety of computing systems, which may include a single processor, multiple processors, multicore processors, or any combination thereof.

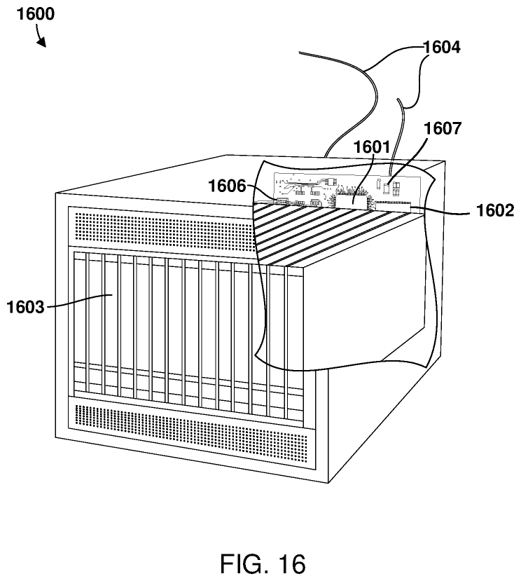

Various embodiments (including, but not limited to, embodiments discussed above with reference to FIGS. 1A-16) may be implemented on a variety of computing devices, an example of which is illustrated in FIG. 16 in the form of a server. With reference to FIGS. 1A-16, the network computing device 1600 (e.g., XR server 110) may include a processor 1601 coupled to volatile memory 1602 and a large capacity nonvolatile memory, such as a disk drive 1603. The network computing device 1600 may also include a peripheral memory access device such as a floppy disc drive, compact disc (CD) or digital video disc (DVD) drive 1606 coupled to the processor 1601. The network computing device 1600 may also include network access ports 1604 (or interfaces) coupled to the processor 1601 for establishing data connections with a network, such as the Internet and/or a local area network coupled to other system computers and servers. The network computing device 1600 may include one or more transceivers 1607 for sending and receiving electromagnetic radiation that may be connected to a wireless communication link. The network computing device 1600 may include additional access ports, such as USB, Firewire, Thunderbolt, and the like for coupling to peripherals, external memory, or other devices.

The processors of the UE 150 and the network device 1600 may be any programmable microprocessor, microcomputer or multiple processor chip or chips that can be configured by software instructions (applications) to perform a variety of functions, including the functions of some implementations described below. In some wireless devices, multiple processors may be provided, such as one processor within an SOC 1504 dedicated to wireless communication functions and one processor within an SOC 1502 dedicated to running other applications. Software applications may be stored in the memory 611, 612 before they are accessed and loaded into the processor. The processors may include internal memory sufficient to store the application software instructions.

Various implementations illustrated and described are provided merely as examples to illustrate various features of the claims. However, features shown and described with respect to any given implementation are not necessarily limited to the associated implementation and may be used or combined with other embodiments that are shown and described. Further, the claims are not intended to be limited by any one example implementation. For example, one or more of the methods and operations of FIGS. 8, 9A, 9B, 11, and 12 may be substituted for or combined with one or more operations of the methods and operations of FIGS. 8, 9A, 9B, 11, and 12.

Implementation examples are described in the following paragraphs. While some of the following implementation examples are described in terms of example methods, further example implementations may include: the example methods discussed in the following paragraphs implemented by a UE including a processor configured with processor-executable instructions to perform operations of the methods of the following implementation examples; the example methods discussed in the following paragraphs implemented by a UE including means for performing functions of the methods of the following implementation examples; and the example methods discussed in the following paragraphs may be implemented as a non-transitory processor-readable storage medium having stored thereon processor-executable instructions configured to cause a processor of a UE to perform the operations of the methods of the following implementation examples.

Example 1. A method for synchronizing resource timings of at least two wireless protocols performed by a processor of a user equipment (UE), the method including: obtaining communication timing information of a user device; sending the communication timing information of the user device to a network node; and configuring first resource timings of an uplink or downlink between the UE and the user device based on the communication timing information.

Example 2. The method of example 1, further including requesting configuration of second resource timings of a further uplink or downlink between the UE and the network node based on the communication timing information.

Example 3. The method of either of examples 1 or 2, in which sending the communication timing information further includes requesting adjustment, by the network node, of a discontinuous reception (DRX) configuration so that a DRX cycle of the UE and a target wake time (TWT) of the user device at least partially coincide.

Example 4. The method of any of examples 1-3, in which configuring the first resource timings further includes adjusting a timing of a target wake time (TWT) based on a discontinuous reception (DRX) configuration for the user device.

Example 5. The method of example 4, in which adjusting the timing of the TWT includes setting a TWT interval and a TWT start based on a DRX cycle and a DRX offset of the UE, respectively, in which the DRX cycle and the DRX offset are configured by the network node.

Example 6. The method of example 4, in which adjusting the timing of the TWT includes setting a TWT minimum wake duration based on a jitter of arrival time of periodic data traffic received by the UE.

Example 7. The method of any of examples 1-6, in which configuring the first resource timings further includes adjusting, for downlink traffic from the UE to the user device, a timing of a target wake time (TWT) based on a discontinuous reception (DRX) configuration of the UE, a physical downlink shared channel (PDSCH) traffic pattern between the UE and the network node, or semi-permanent scheduling of the network node; or.

Example 8. The method of any of examples 1-7, in which configuring the first resource timings further includes adjusting, for uplink traffic from the user device to the UE, a timing of at least one of a bandwidth PUSCH, a configure grant of the network node based on a TWT of the user device, or an assistance message from the user device.

Example 9. The method of any of examples 1-8, in which sending the communication timing information further includes: generating, via a cross-layer application programming interface (API) on the UE, one or more assistance data messages that include the communication timing information of the user device; and transmitting the one or more assistance data messages to the network node.

Example 10. The method of any of examples 1-9, in which configuring the first resource timings further includes adjusting a timing of a TWT of the user device to at least partially coincide with a DRX cycle of the UE based on a DRX configuration for the UE received from the network node.

Example 11. The method of any of examples 1-10, in which configuring the first resource timings further includes adjusting a timing of a TWT of the user device based on downlink traffic from the network node.

Example 12. The method of any of examples 1-11, in which configuring the first resource timings further includes requesting adjustment of a PUSCH resource of the UE to at least partially coincide with a TWT of the user device based on the communication timing information.

Example 13. The method of any of examples 1-12, further including receiving a data generation timing, in which configuring the first resource timings further includes sending to the network node a request to adjust a physical uplink shared channel (PUSCH) resource of the UE based on the data generation timing or sending to the network node a request to adjust the data generation timing.

Example 14. The method of any of examples 1-13, in which configuring the first resource timings further includes adjusting a timing of the uplink from the user device to the UE to at least partially coincide with a further uplink from the UE to the network node based on the communication timing information.

Example 15. The method of any of examples 1-14, in which configuring the first resource timings further includes adjusting a timing of the downlink from the UE to the user device to at least partially coincide with a further downlink from the network node to the UE based on the communication timing information.

Further implementation examples are described in the following paragraphs. While some of the following implementation examples are described in terms of example methods, further example implementations may include: the example methods discussed in the following paragraphs implemented in a network node of a cellular wireless communication network in which the network node includes a processor configured with processor-executable instructions to perform operations of the methods of the following implementation examples; the example methods discussed in the following paragraphs implemented by a network node including means for performing functions of the methods of the following implementation examples; and the example methods discussed in the following paragraphs may be implemented as a non-transitory processor-readable storage medium having stored thereon processor-executable instructions configured to cause a processor of a network node to perform the operations of the methods of the following implementation examples.

Example 16. A method for synchronizing resource timings of at least two wireless protocols performed by a processor of a network node, the method including: receiving, from a user equipment (UE), one or more assistance data messages that include communication timing information of a user device connected to the UE; and configuring a resource timing of the network node based on the communication timing information.

Example 17. The method of example 15, in which configuring the resource timing further includes: adjusting a physical uplink shared channel (PUSCH) resource allocated to the UE to at least partially coincide with a target awake time (TWT) of the user device, a timing of the TWT being included in the communication timing information; and informing the UE of the adjusted PUSCH resource.

Example 18. The method of example 15, in which configuring the resource timing further includes: adjusting a physical uplink shared channel (PUSCH) resource allocated to the UE based on the communication timing information, wherein the communication timing information relates to a data generation timing at the user device; and informing the UE of the adjusted PUSCH resource.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, or a computer. By way of illustration, both an application running on a wireless device and the wireless device may be referred to as a component. One or more components may reside within a process or thread of execution and a component may be localized on one processor or core or distributed between two or more processors or cores. In addition, these components may execute from various non-transitory computer readable media having various instructions or data structures stored thereon. Components may communicate by way of local or remote processes, function or procedure calls, electronic signals, data packets, memory read/writes, and other known network, computer, processor, or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G) as well as later generation 3GPP technology, global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc in which disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A user equipment (UE), comprising:
a first transceiver configured to establish a wireless communication link with a user device;
a second transceiver configured to establish a wireless communication link with a network node of a cellular wireless communication network; and
a processor coupled to the first transceiver and the second transceiver and configured to:
obtain communication timing information of the user device;
send the communication timing information of the user device to the network node; and
configure first resource timings of an uplink or downlink between the UE and the user device based on the communication timing information.

2. The UE of claim 1, wherein the processor is further configured to request configuration of second resource timings of a further uplink or downlink between the UE and the network node based on the communication timing information.

3. The UE of claim 1, wherein the processor is further configured to send the communication timing information by requesting adjustment, by the network node, of a discontinuous reception (DRX) configuration so that a DRX cycle of the UE and a target wake time (TWT) of the user device at least partially coincide.

4. The UE of claim 1, wherein the processor is further configured to configure the first resource timings by adjusting a timing of a target wake time (TWT) based on a discontinuous reception (DRX) configuration for the user device.

5. The UE of claim 4, wherein the processor is further configured to adjust the timing of the TWT by setting a TWT interval and a TWT start based on a DRX cycle and a DRX offset of the UE, respectively, wherein the DRX cycle and the DRX offset are configured by the network node.

6. The UE of claim 4, wherein the processor is further configured to adjust the timing of the TWT by setting a TWT minimum wake duration based on a jitter of arrival time of periodic data traffic received by the UE.

7. The UE of claim 1, wherein the processor is further configured to configure the first resource timings by one or both of
adjusting, for downlink traffic from the UE to the user device, a timing of a target wake time (TWT) based on a discontinuous reception (DRX) configuration of the UE, a physical downlink shared channel (PDSCH) traffic pattern between the UE and the network node, or semi-permanent scheduling of the network node; or
adjusting, for uplink traffic from the user device to the UE, a timing of at least one of a bandwidth physical uplink shared channel (PUSCH), a configure grant of the network node based on a TWT of the user device, or an assistance message from the user device.

8. The UE of claim 7, wherein the processor is further configured to proactively send a scheduling request (SR) for the PUSCH before data is received from the user device by considering one or both of latency of the SR or latency of a buffer status report (BSR).

9. The UE of claim 1, wherein the processor is further configured to send the communication timing information by:
generating, via a cross-layer application programming interface (API) on the UE, one or more assistance data messages that include the communication timing information of the user device; and
transmitting the one or more assistance data messages to the network node.

10. The UE of claim 1, wherein the processor is further configured to configure the first resource timings by adjusting a timing of a target wake time (TWT) of the user device to at least partially coincide with a discontinuous reception (DRX) cycle of the UE based on a DRX configuration for the UE received from the network node.

11. The UE of claim 1, wherein the processor is further configured to configure the first resource timings by adjusting a timing of a target wake time (TWT) of the user device based on downlink traffic from the network node.

12. The UE of claim 1, wherein the processor is further configured to configure the first resource timings by requesting adjustment of a physical uplink shared channel (PUSCH) resource of the UE to at least partially coincide with a TWT of the user device based on the communication timing information.

13. The UE of claim 1, wherein the processor is further configured to:
receive a data generation timing; and
configure the first resource timings by sending to the network node a request to adjust a physical uplink shared channel (PUSCH) resource of the UE based on the data generation timing or sending to the network node a request to adjust the data generation timing.

14. The UE of claim 1, wherein the processor is further configured to configure the first resource timings by one or both of:
adjusting a timing of the uplink from the user device to the UE to at least partially coincide with a further uplink from the UE to the network node based on the communication timing information; or
adjusting a timing of the downlink from the UE to the user device to at least partially coincide with a further downlink from the network node to the UE based on the communication timing information.

15. A method for synchronizing resource timings of at least two wireless protocols performed by a processor of a user equipment (UE), the method comprising:
obtaining communication timing information of a user device;
sending the communication timing information of the user device to a network node; and
configuring first resource timings of an uplink or downlink between the UE and the user device based on the communication timing information.

16. The method of claim 15, further comprising requesting configuration of second resource timings of a further uplink or downlink between the UE and the network node based on the communication timing information.

17. The method of claim 15, wherein sending the communication timing information further comprises requesting adjustment, by the network node, of a discontinuous reception (DRX) configuration so that a DRX cycle of the UE and a target wake time (TWT) of the user device at least partially coincide.

18. The method of claim 15, wherein configuring the first resource timings further comprises adjusting a timing of a target wake time (TWT) based on a discontinuous reception (DRX) configuration for the user device.

19. The method of claim 18, wherein adjusting the timing of the TWT comprises setting a TWT interval and a TWT start based on a DRX cycle and a DRX offset of the UE, respectively, wherein the DRX cycle and the DRX offset are configured by the network node.

20. The method of claim 18, wherein adjusting the timing of the TWT comprises setting a TWT minimum wake duration based on a jitter of arrival time of periodic data traffic received by the UE.

21. The method of claim 15, wherein configuring the first resource timings further comprises one or both of:
adjusting, for downlink traffic from the UE to the user device, a timing of a target wake time (TWT) based on a discontinuous reception (DRX) configuration of the UE, a physical downlink shared channel (PDSCH) traffic pattern between the UE and the network node, or semi-permanent scheduling of the network node; or
adjusting, for uplink traffic from the user device to the UE, a timing of at least one of a bandwidth physical uplink shared channel (PUSCH), a configure grant of the network node based on a TWT of the user device, or an assistance message from the user device.

22. The method of claim 21, further comprising the UE proactively sending a scheduling request (SR) for the PUSCH before data is received from the user device by considering one or both of latency of the SR or latency of a buffer status report (BSR).

23. The method of claim 15, wherein sending the communication timing information further comprises:
generating, via a cross-layer application programming interface (API) on the UE, one or more assistance data messages that include the communication timing information of the user device; and
transmitting the one or more assistance data messages to the network node.

24. The method of claim 15, wherein configuring the first resource timings further comprises adjusting a timing of a target wake time (TWT) of the user device to at least partially coincide with a discontinuous reception (DRX) cycle of the UE based on a DRX configuration for the UE received from the network node.

25. The method of claim 15, wherein configuring the first resource timings further comprises adjusting a timing of a target wake time (TWT) of the user device based on downlink traffic from the network node.

26. The method of claim 15, wherein configuring the first resource timings further comprises requesting adjustment of a physical uplink shared channel (PUSCH) resource of the UE to at least partially coincide with a TWT of the user device based on the communication timing information.

27. The method of claim 15, further comprising receiving a data generation timing,
wherein configuring the first resource timings further comprises sending to the network node a request to adjust a physical uplink shared channel (PUSCH) resource of the UE based on the data generation timing or sending to the network node a request to adjust the data generation timing.

28. The method of claim 15, wherein configuring the first resource timings further comprises one or both of:
adjusting a timing of the uplink from the user device to the UE to at least partially coincide with a further uplink from the UE to the network node based on the communication timing information; or
adjusting a timing of the downlink from the UE to the user device to at least partially coincide with a further downlink from the network node to the UE based on the communication timing information.

29. A computing device for uses as a network node in a cellular wireless communication network, the computing device comprising:
a processor configured with processor-executable instruction to:
receive, from a user equipment (UE), one or more assistance data messages that include communication timing information of a user device connected to the UE;
configure a resource timing of the network node based on the communication timing information by either:
adjusting a physical uplink shared channel (PUSCH) resource allocated to the UE to at least partially coincide with a target awake time (TWT) of the user device, a timing of the TWT being included in the communication timing information; or
adjusting a PUSCH resource allocated to the UE based on the communication timing information, wherein the communication timing information relates to a data generation timing at the user device; and.
inform the UE of the adjusted PUSCH resource.

30. A method for synchronizing resource timings of at least two wireless protocols performed by a processor of a network node, the method comprising:
receiving, from a user equipment (UE), one or more assistance data messages that include communication timing information of a user device connected to the UE;
configuring a resource timing of the network node based on the communication timing information by either:
adjusting a physical uplink shared channel (PUSCH) resource allocated to the UE to at least partially coincide with a target awake time (TWT) of the user device, a timing of the TWT being included in the communication timing information; or
adjusting a PUSCH resource allocated to the UE based on the communication timing information, wherein the communication timing information relates to a data generation timing at the user device; and informing the UE of the adjusted PUSCH resource.
